(19) United States
(12) Patent Application Publication
(10) Pub. No.: US 2002/0165754 A1
(43) Pub. Date: Nov. 7, 2002

(54) Method for quality of service controllable real-time scheduling

(76) Inventors: Ming-Chung Tang, Jubei City (TW); Wei-Kuan Shih, Shulin City (TW); Wen-Hsin Yang, Hsinchu (TW)

Correspondence Address: RABIN & CHAMPAGNE, P.C., Suite 500, 1101 14th Street, N.W., Washington, DC, 20005, US

(21) Appl. No.: 10/057,963

(22) Filed: Jan. 29, 2002

(30) Foreign Application Priority Data
Feb. 27, 2001 (TW) 090104621

(51) Int. Cl. G06F 17/60

(52) U.S. Cl. 705/9; 700/99

(57) ABSTRACT

A mechanism for quality-of-service-controllable real-time scheduling. The mechanism can be implemented by an apparatus including a regulator, an on-line scheduler, and an evaluator. The regulator is used for adjusting the number of tasks inputted into the on-line scheduler. The on-line scheduler is used to select a real-time scheduling method for configuring time intervals for inputted tasks to be executed. The evaluator is used to evaluate a scheduling result of the on-line scheduler for feeding a first set of parameters into the regulator for a coarse adjustment, and feeding a second set of parameters into the on-line scheduler for a fine adjustment. Besides, for the fulfillment of real-time scheduling, three scheduling methods, namely, MOS, MOP, and MOF methods, are provided. In the MOS method, the mandatory portions are executed as soon as possible and the optional portions may be substitutable. In the MOP method, the mandatory portions are executed as soon as possible, and the substitutable optional portions are to be postponed. In the MOF method, the mandatory portions are executed as soon as possible, and the optional portions will be executed fairly.

This application incorporates by reference Taiwanese application Serial No. 90104621, filed on Feb. 27, 2001.

### BACKGROUND OF THE INVENTION

Field of the Invention

The invention relates in general to a scheduling mechanism, and more particularly to a scheduling mechanism for use in network transmission, which is quality of service (QoS) controllable and fulfils real-time scheduling. Description of the Related Art

For the several decades, computers are among the most important inventions that have significant effects on people. As computer technology progresses generation by generation, computers are heavily involved in the daily lives of the users. With one computer, one can only process ones' own tasks. In contrast, with two or more computers connected together to build up a computer network, users can share resources and communicate with each other as well as the users' tasks. Likewise, computer networks have been changing our daily lives, friendships and working in many aspects.

Referring to FIG. 1, it illustrates a network transmitting system. For sending digital data 101 to receiving end 112, transmitting end 102 first divides digital data 101 into a plurality of packets 103. Packets 103 are then encoded by encoder 104 of transmitting end 102. The encoded packets are transmitted to router 108 in network 106. After router 108 receives packets 105, router 108 obtains the destination that packets 105 are to be sent to, and assigns a transmission path for sending packets 105 to receiving end 112. Finally, digital data 101 is obtained in receiving end 112 after decoder 110 of receiving end 112 decodes packets 105.

When packets 105 arrive at router 108 from different transmitting end 102, router 108 is required to send packets 105 to different receiving end 112 according to the request from transmitting end 102 and router 108 is to assign a transmission sequence for packets 105 and transmit packets 105 according to the transmission sequence. During transmission, the packets left to be sent are temporarily stored in router 108 so as to wait to be transmitted. Since the bandwidth of network 106 is fixed and limited, only a certain number of packets are allowed to be transmitted over network 106. If an excess of packets is to be transmitted over network 106 at the same time, it results in network congestion. In the case of severe network congestion, since the number of the packets flowing into router 108 exceeds the maximum number of packets that router 108 can handle simultaneously, router 108 will discard some of packets being received so as to reduce the load. In this way, receiving end 112 cannot receive all packets of the digital data and the quality of service (QoS) that network 106 provides for users is reduced. In the worse case, receiving end 112 cannot operate because some packets of important data cannot be received completely.

Referring to FIGS. 2A-2B, it illustrates a traditional packet flow control concept. In order to maintain QoS of the network and reduce the load of the router, the router is to perform network flow control according to a mechanism. Referring to FIG. 2A, faucet 202 is used to pour water into bucket 204 at a constant rate. On the other hand, since bucket 204 has a hole on the bottom, bucket 204 is leaking water at another constant rate. If faucet 202 is pouring water into bucket 204 at a rate not greater than the rate of the water being leaked from bucket 204, all of the water from faucet 202 can pour out of bucket 204 through the hole. Besides, the time that the water pours from faucet 202 and waits in bucket 204 depends on the relation between the rate of pouring water from faucet 202 and the rate of leaking water of bucket 204. If the rate of pouring water from faucet 202 is greater than the rate of leaking water of bucket 204, the amount of water of bucket 204 left to be leaked are increasing. Once bucket 204 is full, any water added to bucket 204 overflows and cannot leak from the hole of bucket 204.

Similarly, the concept illustrated above can apply to network transmission services. Referring to FIG. 2B, host 206 is connected to router 208 in the network. Host 206 transmits packets 207 to router 208 at a fixed rate while router 208 has a queue 210 with a limited length which is used to store a specific number of packets 207 waiting to be processed. When a task arrives at router 208 with queue 210 having vacancy, packets 207 of the task are to be added to queue 210 at a certain rate. If queue 210, which the packets 207 are added to, has already been full, they will be discarded. This mechanism adjusts the number of packets arrives at router 208 and is called leaky bucket mechanism.

Referring to FIG. 3, it illustrates a flow control mechanism for network packets. The method shown in FIG. 3 is the widely used flow control mechanism which is similar to leaky bucket mechanism and is called token bucket mechanism. Since it is difficult to achieve transmission and arrival of packets in real-time, most of the packets arrived at a router are not assigned the properties that are necessary to process tasks in traditional real-time systems, such as arrival time, processing time, and deadline. For the sake of convenience and making emphasis on real-time characteristics, an item to be processed in a system is denoted a task. For instance in the network layer, transmitting a packet is regarded as a task in a real-time system. For instance in the application layer, sending a file is considered as a task in a real-time system. For a real-time operating system, a program module waiting to be executed is a task in a real-time system as well.

Referring to FIG. 3, a token 302 enters bucket 304 at a specific rate p and bucket 304 has a specific capacity, that is, a maximum number σ of tokens that can be put in bucket 304. When a task arrives in queue 306 with capacity Q_{L}, the task is scheduled to wait in queue 306 if queue 306 has vacancy. If queue 306 is full, the task is discarded. Besides, in order to be further processed, the task waiting in queue 306 has to obtain a token 302 out of bucket 304. In this way, the rate of leaking tokens out of bucket 304 determines the rate that the task enters a successive system for processing. Therefore, we can adjust the rate and number of tasks flowing into the system by adjusting the queue length Q_{L} of queue 306, the token rate p and token size σ of token 302.

The main principle of token bucket mechanism is that a traditional router determines the execution priority of the packet according to the importance of each received packet. More important packet is scheduled in a preceding location in a queue so that it has higher priority. The router spends more time on the packet with higher priority. Conversely, the router spends less time on less important packet. In some case, the router even discards some packets.

The conventional flow control mechanism has following problems.

First, the conventional flow control mechanism is inherently to reduce processing time of some task so as to execute another task on time. However, the characteristics of packets in network transmission may have great differences. It is difficult to make a standard to specify which kind of packets are more important, which kind of packets must be transmitted first, which kind of packets are of less importance, and which kind of packets can be discarded if necessary. Even though such standard is made, if some packets do not meet the requirement of being more important and they are often discarded by a router, it would bring the users great inconvenience. In this case, the QoS provided for the users is degraded and the efficiency and convenience of using network is reduced.

On the other hand, though a task is assigned to be important and processed as the highest priority, not all of the data in the task have equal importance. If only a portion of data in the task is important, the router is unnecessary to regard all of the data in the task as important data to be processed. It only needs to process the important portion of data in real-time. For example in a router with packet transmission mechanism, for the highest priority task, not all of the packet are necessary to be sent to the receiving end so as to make the receiving end process the task. Sending the important portion of data to the receiving end is sufficient to make the receiving end process the task. In the way, it is unfair that the network resource is used to process the unimportant portion of the task with the highest priority so that the other tasks are not to be processed.

Finally, if an excess number of packets are to be processed simultaneously and, consequently, the network congestion occurs in the network, then a portion of the packets are still discarded by the router so that most of the receiving ends cannot receive all data through the network although the traditional packet flow control method is used. In other words, although network transmission efficiency is kept, all tasks being processed cannot be completed. In this case, the network provides inefficient and degraded quality of service.

As described above, the token bucket mechanism for resolving network congestion has two disadvantages: unfairness in network resource sharing and incapability of processing in real-time.

### SUMMARY OF THE INVENTION

It is therefore an object of the invention to provide a quality-of-service-controllable (QoS-controllable) scheduling mechanism for (i) the enhancement of fairness of network resource sharing and (ii) use in a real-time system to realize on-line scheduling.

The invention achieves the above-identified object by providing a quality-of-service-controllable (QoS-controllable) real-time scheduling mechanism. The mechanism can be fulfilled by an apparatus for QoS-controllable real-time scheduling. The apparatus includes a regulator, an on-line scheduler, and an evaluator. The regulator is for receiving a plurality of tasks for the apparatus. The on-line scheduler, coupled to the regulator, is used for selecting a real-time scheduling method and receiving a number of the tasks, wherein the number of the tasks which are inputted to the on-line scheduler are adjusted by the regulator, and the on-line scheduler, according to the real-time scheduling method, is to configure time intervals for inputted tasks to be executed. The evaluator, coupled to the regulator and the on-line scheduler, is used for evaluating a scheduling result of the on-line scheduler, feeding a first set of parameters into the regulator for a coarse adjustment, and feeding a second set of parameters into the on-line scheduler for a fine adjustment.

In addition to the apparatus described above, the mechanism can be achieved by a method for QoS-controllable real-time scheduling. The method includes the steps as follows. (a) Regulate the number of input tasks which are to be forwarded to an on-line scheduling unit through a regulating unit. (b) By the on-line scheduling unit, select a real-time scheduling method, schedule tasks forwarded to the on-line scheduling unit according to the real-time scheduling method, and output a scheduling result. (c) By an evaluating unit, evaluate the scheduling result, feed a first set of parameters into the regulating unit for a coarse adjustment, and feed a second set of parameters into the on-line scheduler for a fine adjustment. In addition, the regulating unit, the on-line scheduling unit, and the evaluating unit can be implemented as respective software routines.

In the invention, an on-line scheduling method, such as an imprecise computation model, is used for scheduling. According to the on-line scheduling method, the tasks inputted into the on-line scheduler are scheduled in the reservation list. The tasks will then be executed according to the scheduled sequence indicated in the reservation list. Each of the tasks to be scheduled is divided into two portions: mandatory portion and optional portion. The mandatory portion of a task is required to be executed while the optional portion of the task need not be executed and may be discarded partially or completely.

Besides, the invention provides a method for 1-task-look-ahead substitutable checking for use in a real-time scheduling mechanism for scheduling a plurality of tasks. The method is proceeded as the mandatory portion of each task scheduled in a reservation list is completed. In addition, the plurality of tasks T include respective mandatory portions M and optional portions O. The mandatory portions M of the plurality of tasks T are scheduled in the reservation listis Mᵢ according to a model so that each of the mandatory portions Mᵢ scheduled in the reservation list has a starting time sᵢ and an ending time fᵢ. For each of the tasks Tᵢ, the mandatory portion Mᵢ has a processing time mᵢ, the optional portion Oᵢ has a processing time oᵢ, where the subscript i indexes a sequence of starting time for the mandatory portions M scheduled in the reservation list. After the mandatory portion Mᵢ of each of the tasks Tᵢ is completed, the method for 1-tasks-look-ahead substitutable checking is performed on the task Tᵢ. The method includes the following steps. (a) An effective interval tᵢ is determined according to the starting time sᵢ₊₁ of the mandatory portion Mᵢ₊₁ of a task Tᵢ₊₁, the ending time fᵢ of the mandatory portion Mᵢ of a task Tᵢ, and an interval for the processing time oᵢ of the optional portion Oᵢ of the task Tᵢ. (b) The mandatory portion Mᵢ₊₁ is moved to a location in the reservation list by setting the starting time sᵢ₊₁ of the mandatory portion Mᵢ₊₁ to be the ending time fᵢ of the mandatory portion Mᵢ and by changing the ending time fᵢ₊₁ of the mandatory portion Mᵢ₊₁ correspondingly. (c) An effective interval tᵢ₊₁ is determined according to the starting time sᵢ₊₂ of the mandatory portion Mᵢ₊₂ of a task Tᵢ₊₂, the ending time fᵢ₊₁ of the mandatory portion Mᵢ₊₁, and an interval for the processing time oᵢ₊₁ of the optional portion Oᵢ₊₁ of the task Tᵢ₊₁. (d) The effective interval tᵢ is compared with the effective interval tᵢ₊₁; if the effective interval tᵢ is less than the effective interval tᵢ₊₁, the optional portion Oᵢ of the task Tᵢ is 1-task-look-ahead substitutable; if the effective interval tᵢ is greater than the effective interval tᵢ₊₁, the optional portion Oᵢ of the task Tᵢ is not 1-task-look-ahead substitutable.

Further, the invention provides a method for k-tasks-look-ahead substitutable checking for use in a real-time scheduling mechanism for scheduling a plurality of tasks, where k is a positive integer greater than one. The method is proceeded as the mandatory portion of each task scheduled in a reservation list is completed. In addition, the plurality of tasks T include respective mandatory portions M and optional portions O. The mandatory portions M of the plurality of tasks T are scheduled in the reservation list according to a model so that each of the mandatory portions Mᵢ scheduled in the reservation list has a starting time sᵢ and an ending time fᵢ. For each of the tasks Tᵢ, the mandatory portion Mᵢ has a processing time mᵢ, the optional portion Oᵢ has a processing time oᵢ, where the subscript i indexes a sequence of starting time for the mandatory portions M scheduled in the reservation list. After the mandatory portion Mᵢ of each of the tasks Tᵢ is completed, the method for k-tasks-look-ahead substitutable checking is performed on the task Tᵢ. The method includes the following steps. (a) An effective interval tᵢ is determined according to the starting time sᵢ₊₁ of the mandatory portion Mᵢ₊₁ of a task Tᵢ₊₁, the ending time fᵢ of the mandatory portion Mᵢ of a task Tᵢ, and an interval for the processing time oᵢ of the optional portion Oᵢ of the task Tᵢ. (b) A is set to be one. (c) The mandatory portion M_{i+A} of a task T_{i+A} is moved to a location in the reservation list by setting the starting time s_{i+A} of the mandatory portion M_{i+A} to be the ending time f_{i+A-1} of the mandatory portion M_{i+A} of a task T_{i+A} and by changing the ending time fᵢA of the mandatory portion M_{i+A} correspondingly. (d) An effective interval t_{i+A} is determined according to the starting time s_{i+A-1} of the mandatory portion M_{i+A-1} of a task T_{i+A-1}, the ending time f_{i+A-1} of the mandatory portion M_{i+A-1}, and an interval for the processing time O_{i+A} of the optional portion O_{i+A} of the task T_{i+A}. (e) If A is less than k, A is incremented by one and the method proceeds to step (c). (f) An effective interval r is determined by using the effective intervals tᵢ₊₁ to tᵢ₊ₖ. (g) The effective interval tᵢ is compared with the effective interval r; if tᵢ is less than r, the optional portion Oᵢ of the task Tᵢ is k-tasks-look-ahead substitutable; if tᵢ is greater than r, the optional portion Oᵢ of the task Tᵢ is not k-tasks-look-ahead substitutable.

By using an improved imprecise computation model associated with the k-tasks-look-ahead substitutable check, the invention further provides three scheduling methods (1) MOS method: the scheduling method in which the Mandatory portions are executed as soon as possible and the Optional portions are Substituted as much as possible; (2) MOP method: the scheduling method in which the Mandatory portions are executed as soon as possible, and the substitutable Optional portions are to be Postponed; and (3) MOF method: the scheduling method in which the Mandatory portions are executed as soon as possible, and the Optional portions are to be executed Fairly. In a real-time scheduling apparatus, the on-line scheduler selects a scheduling method according to the circumstances such as the number of tasks inputted into the real-time scheduling apparatus and the degree of network congestion. The three scheduling methods are described as follows.

In the MOS method, the mandatory portions of the tasks are first scheduled in the reservation list according to an imprecise computation model. Next, the first task, that is, the task with the earliest deadline, begins to be executed. If this task is completed, or the deadline of this task has reached, or it must begin to execute the next task, the current task is removed from the on-line scheduler. If there is a new task to be scheduled, the scheduling result in the reservation list is to be modified and the new task is added in the reservation list. If the mandatory portion of the task is completed, a determination is made whether the optional portion of the task is k-tasks-look-ahead substitutable. If so, the task is to be removed from the reservation list and the next task in the reservation list is to be executed. If not, the optional portion of the task is to be executed. The steps above are repeated until there is no task in the on-line scheduler.

The MOP and MOF methods are similar to the MOS method. In the MOP method, when the optional portion of the task is determined to be k-tasks-look-ahead substitutable by using the k-tasks-look-ahead substitutable check, a determination is made whether it is to execute the optional portion of the task within a spare interval by using the spare interval between the mandatory portion of the task and the optional portion of the next task to be executed is to executed. As for the MOF method, when the optional portion of the task is determined to be k-tasks-look-ahead substitutable by using the k-tasks-look-ahead substitutable check, the length of the spare interval between the mandatory portion of the current task and the mandatory portion of the next task to be executed is first determined. Next, the spare interval is equally distributed among the optional portion of the current task and the optional portions associated with a block of consecutive mandatory portions including the next mandatory portion to be executed so that the optional portion of the current task and the optional portions associated with the block of consecutive mandatory portions have respective equal-length time intervals for execution.

Other objects, features, and advantages of the invention will become apparent from the following detailed description of the preferred but non-limiting embodiments. The following description of the invention is made with reference to the accompanying drawings.

### BRIEF DESCRIPTION OF THE DRAWINGS

FIG. 1 (Prior Art) illustrates a network transmission system.

FIG. 2A (Prior Art) illustrates the concept of packet flow control.

FIG. 2B (Prior Art) illustrates the concept of packet flow control.

FIG. 3 (Prior Art) illustrates a conventional mechanism for network packet flow control.

FIG. 4 is a block diagram illustrating a real-time scheduling mechanism according to a preferred embodiment of the invention.

FIGS. 5A-5B illustrate the determination of the locations of the tasks in the reservation list by using an imprecise computation model.

FIGS. 6A-6B illustrate performing k-tasks-look-ahead substitutable check on the tasks in the reservation list.

FIGS. 7A-7D illustrate performing k-tasks-look-ahead substitutable check on the tasks in the reservation list.

FIGS. 8A-8B illustrate performing k-tasks-look-ahead substitutable check on the tasks in the reservation list, where k is an integer greater than one.

FIGS. 9A-9B illustrate the processing using the MOP method when the optional portion is k-tasks-look-ahead substitutable.

FIGS. 10A-10B illustrate the processing using the MOF method when the optional portion is k-tasks-look-ahead substitutable.

FIGS. 11A-11B illustrate the processing using the MOF method when the optional portion is k-tasks-look-ahead substitutable.

FIG. 12A illustrates a scheduling result after the on-line scheduler puts tasks into the reservation list by using the MOS method.

FIG. 12B illustrates a scheduling result after the on-line scheduler puts tasks into the reservation list by using the MOP method.

FIG. 12C illustrates a scheduling result after the on-line scheduler puts tasks into the reservation list by using the MOF method.

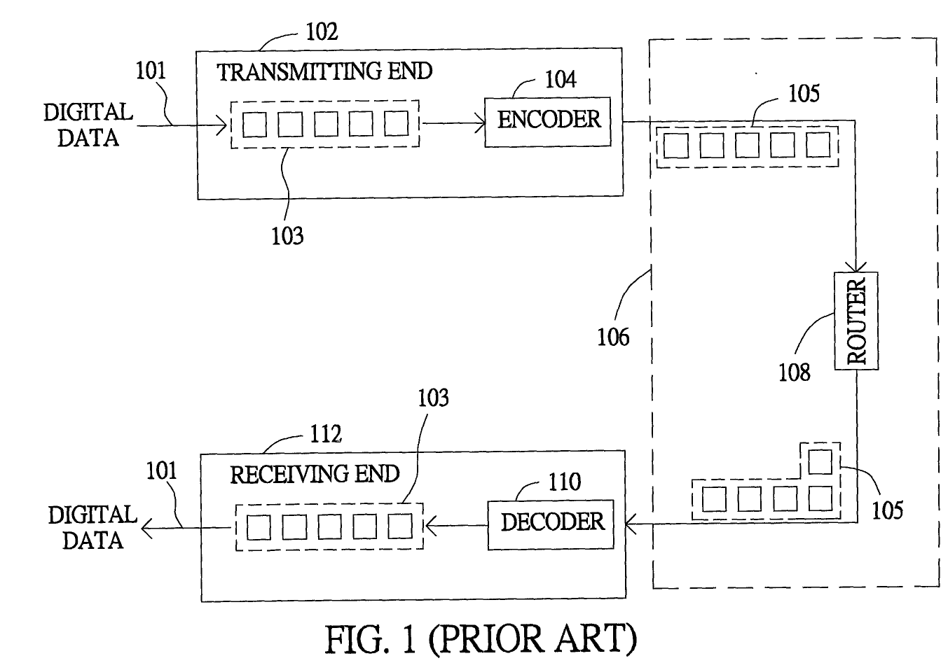

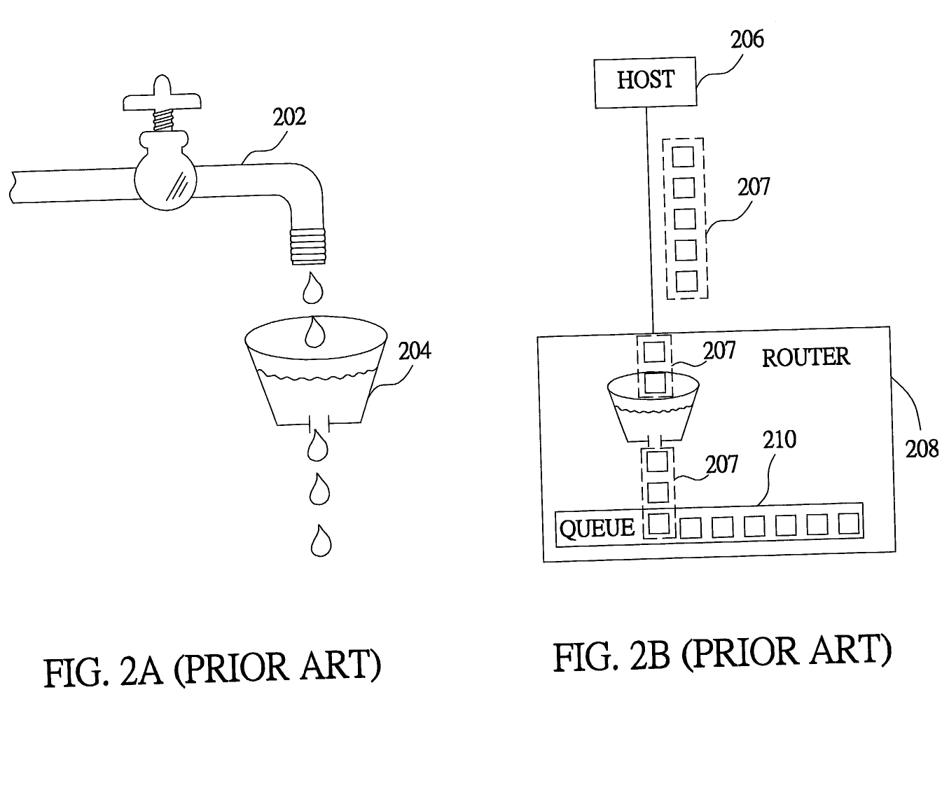

### DETAILED DESCRIPTION OF THE INVENTION

The purpose of the invention is to provide a real-time scheduling mechanism. In the real-time scheduling mechanism, each of the tasks to be scheduled is divided into two portions: mandatory portion and optional portion. Mandatory portion of a task is a portion of the task which is required and must be executed while optional portion of the task is a portion of the task which needs not be executed and can be discarded partially or completely. This division is a feature of the invention. In addition, the real-time scheduling mechanism is capable of performing coarse and fine adjustments. Further, by controlling the amount of the optional portion of the task to be executed, the real-time scheduling mechanism achieves fairness of scheduling and real-time requirement for scheduling.

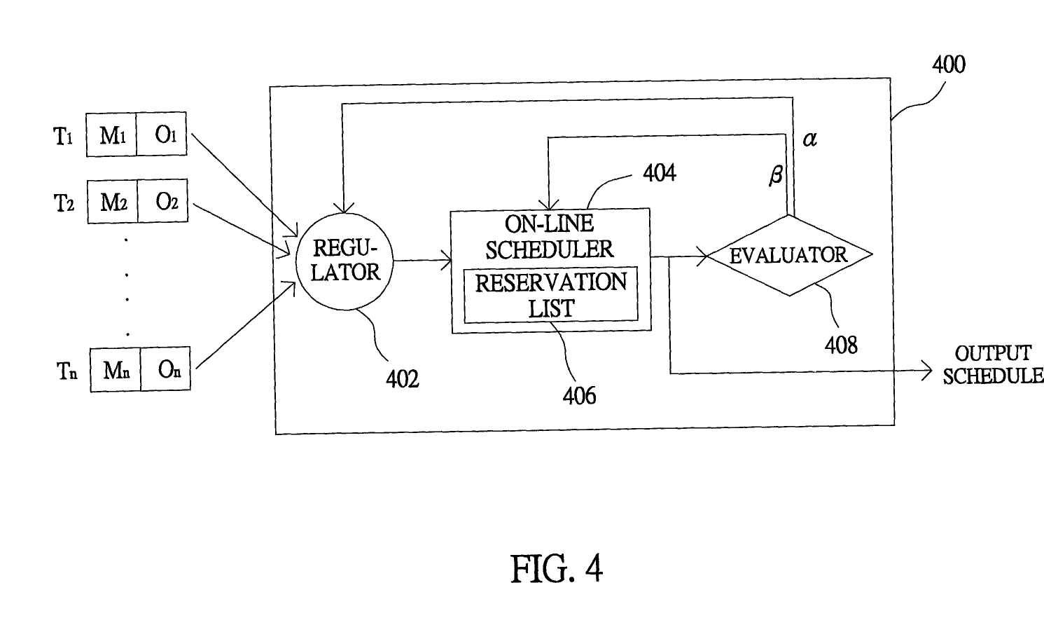

Referring to FIG. 4, it illustrates the real-time scheduling mechanism according to the invention, which is quality-of-service-controllable (QoS-controllable). As described above, all tasks to be scheduled by real-time scheduling mechanism 400 are divided into respective mandatory portions and optional portions. The real-time scheduling mechanism 400 includes a regulator 402, an on-line scheduler 404, and an evaluator 408.

The regulator 402 is used for adjusting the number of a plurality of tasks to be inputted into the on-line scheduler 404.

The on-line scheduler 404 is coupled to the regulator 402 and is employed to select a real-time scheduling method, and put the tasks into a reservation list 406 according to the real-time scheduling method so as to configure time intervals for the tasks to be executed.

The evaluator 408, coupled to the regulator 402 and the on-line scheduler 404, is used to evaluate a scheduling result of the on-line scheduler 404, feed a first set of parameters α into the regulator 402 for a coarse adjustment, and feed a second set of parameters β into the on-line scheduler 404 for a fine adjustment.

It should be noted that the regulator 402, the on-line scheduler 404, and the evaluator 408 in the real-time scheduling mechanism 400 can be implemented by software routines as well as hardware components. For example in the real-time scheduling mechanism by software routines, the regulator, the on-line scheduler, and the evaluator for the real-time scheduling software system may be regarded as three different units, such as three processes operating the same as the regulator 402, the on-line scheduler 404, and the evaluator 408 respectively.

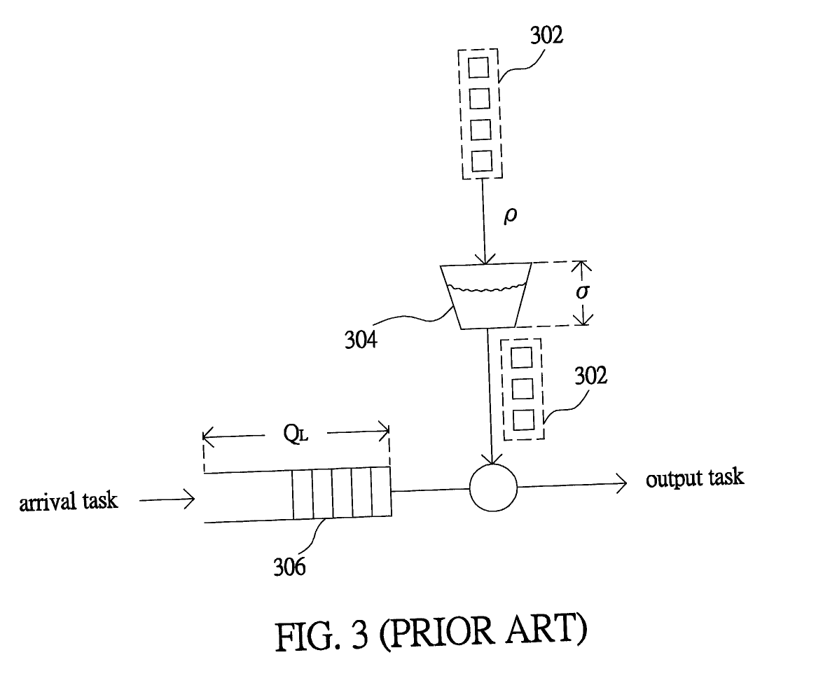

Tasks inputted into the real-time scheduling mechanism 400 are first received by the regulator 402. The regulator 402 is to adjust the number of tasks fed into the on-line scheduler 404, wherein the mechanism for adjustment is a flow control mechanism such as the token bucket mechanism shown in FIG. 3. By using this flow control mechanism, the rate and number of tasks that are fed into the on-line scheduler 404 are controlled so that a scheduling result produced by the on-line scheduler 404 achieves real-time scheduling and fulfils the requirement that all of the mandatory portions of the tasks fed into the on-line scheduler 404 are to be executed completely by the deadlines of these tasks while all of the optional portions of these tasks are to be executed as much as possible. Besides, the regulator 402 is capable of receiving the first set of parameters α which are fed into the regulator 402 by the evaluator 408. According to the values of the first set of parameters α, the regulator 402 performs a coarse adjustment on parameters in the token bucket mechanism, such as token generation rate β, token number σ, and queue length Q_{L}.

After the adjustment with the token bucket mechanism at the regulator 402, a number of the tasks inputted into the real-time scheduling mechanism 400 are fed into the on-line scheduler 404. Then, the on-line scheduler 404, coupled to the regulator 402, is to select a real-time scheduling method according to the current status of the real-time scheduling mechanism 400 so as to put the tasks which are fed into the on-line scheduler 404 by the regulator 402 into the reservation list 406. In this way, the tasks in the reservation list 406 are to be executed sequentially according to the order of the tasks in the reservation list 406.

For improving the fairness of resource sharing so as to cause as many mandatory portions to be executed as possible under required QoS, and fulfilling the requirement of real-time scheduling according to the characteristics of the real-time network transmission, the on-line scheduler 404 employs an imprecise computation model. When there are tasks to be scheduled, the on-line scheduler 404 reserves a time interval for the mandatory portion of each of the tasks. That is, a time interval in the reservation list 406 is reserved for the mandatory portion of each task. Besides, the determination of intervals reserved for each mandatory portion in the reservation list 406 is to put the mandatory portions of the tasks into the reservation list 406 according to the deadlines of the tasks in the following manner. The task with the latest deadline is first put into the end of the reservation list 406; that is, this task is scheduled to be completed at or before its deadline. Next, the task with a latest deadline in the remaining tasks is similarly put into the reservation list 406 until each of the tasks is scheduled to be completed at or before its deadline in the reservation list 406. After the mandatory portions of all tasks are scheduled in the reservation list 406, intervals within which no scheduled task is to be executed are available for the scheduling of the optional portions of the tasks for execution. As the on-line scheduler 404 is performing scheduling for a plurality of tasks, if an additional task is fed into the on-line scheduler 404, this task is to be scheduled in the reservation list 406 and the time intervals for the scheduled mandatory portions in the reservation list 406 are to be modified accordingly.

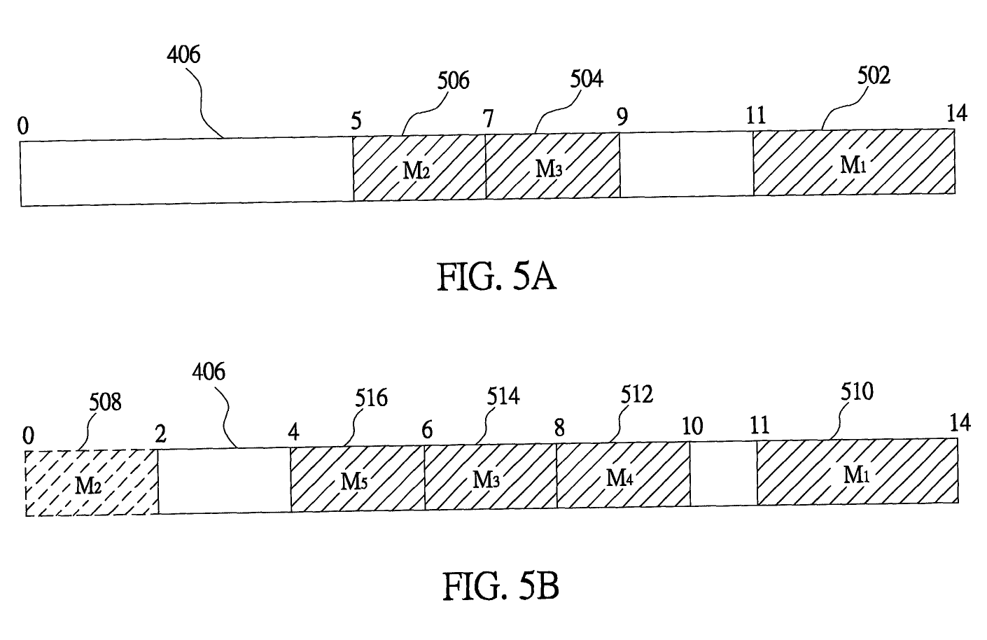

Referring to FIGS. 5A-5B, they illustrate the determination of the time intervals reserved for the tasks in the reservation list by using an imprecise computation model. In addition, TABLE 1 specifies the parameters of the tasks scheduled in the reservation list, wherein the tasks are divided into respective mandatory and optional portions and all of the parameters are in the same time unit. In TABLE 1, the time required to execute the mandatory portion of each task, or called the processing time of the mandatory portion of each task, is specified in the column m and can be denoted by mᵢ, where subscript i is equal to the subscript of the associated task. The time required to execute the optional portion of each task, or called the processing of the optional portion of each task, is specified in the column o and can be denoted by oᵢ. Each task has an arrival time specifying when the task arrives at the on-line scheduler 404 and can be denoted by aᵢ. In addition, each task has a deadline, denoted by dᵢ, specifying the time by which the task should be completed by and is to be removed from the on-line scheduler 404.

TABLE 1

| | a | d | m | o |
|---|---|---|---|---|
| T₁ | 0 | 14 | 3 | 4 |
| T₂ | 0 | 8 | 2 | 3 |
| T₃ | 0 | 9 | 2 | 4 |
| T₄ | 2 | 10 | 2 | 3 |
| T₅ | 2 | 6 | 2 | 4 |

In FIGS. 5A-5B, the numbers immediately placed in the upper side of the rectangle indicative of the reservation list 406 are time instants specifying the time intervals reserved for the mandatory portions of the tasks to be executed. For example, mandatory portion M₂ of task T₂ is scheduled to be executed during time 5 to time 7, and mandatory portion M₂ of task T₂ during time 11 to time 14. As specified in TABLE 1, at time zero, three tasks T₁ to T₃ are inputted into the on-line scheduler 404 and the on-line scheduler 404, according to the latest-deadline-first principle, schedules the mandatory portions of the tasks in the reservation list 406 in the order of T₁, T₃, and T₂ from the end to the beginning of the reservation list 406. Firstly, mandatory portion M₁ of task T₁ is scheduled to be executed in the time interval 502 of the reservation list 406 which begins at time 11 and ends at time 14. In other words, mandatory portion M₁ of task T₁ is scheduled in the time interval 502 and has a starting time at time 11 and an ending time at time 14. Similarly, mandatory portion M₃ of task T₃ is scheduled to be executed in the time interval 504 of the reservation list 406 and has a starting time at time 7 and an ending time at time 9. For mandatory portion M₂ of task T₂, task T₂ has a deadline at time 8 which is in the middle of the time interval 504 for mandatory portion M₃ of task T₃, and thus mandatory portion M₂ of task T₂ is scheduled to be executed earlier in the time interval 506 of the reservation list 406 which begins at time 5 and ends at time 7.

As can be seen from FIG. 5B, the reservation list 406 has no scheduled task during time zero to time two. For improving the scheduling efficiency of the on-line scheduler 404 and making use of the idle intervals in the reservation list 406, the on-line scheduler 404 is to execute the task with the earliest starting time in advance. Mandatory portion M₂ as shown in FIG. 5A has the earliest starting time at time five. Thus, the starting time of mandatory portion M₂ is advanced so that the time interval 506 of 2 time unit length is moved to the time interval beginning at time zero and ended at time two. That is, the time interval 508 as shown in FIG. 5B is for the execution of mandatory portion M₂. Consequently, mandatory portion M₂ will be completed by time two. For the sake of illustration, when a task has been executed, the time interval reserved for this task will be shown with dotted border and lines in the reservation list 406 to indicate its completion. For example, after time 2, the task M₂ has been executed and the time interval 508 is shown as shown in FIG. 5B.

Referring to FIG. 5B, it illustrates that the on-line scheduler 404 has changed the time intervals reserved for the mandatory portions of the tasks in the reservation list 406 since new tasks T₄ and T₅ arrived at the on-line scheduler 404 at time two. The time interval reserved for mandatory portion M₁ need not be changed, and time interval 510 for mandatory portion M₁, which begins at time 11 and ends at time 14, is identical to the interval 502 in FIG. 5A. In addition, task T₄ has a deadline later than that of T₅. Thus, according to the way of scheduling as above, mandatory portion M₄ of task T₄ is scheduled in the time interval 512 of the reservation list 406, wherein the time interval 512 begins at time 8 and ends at time 10. In the meantime, for avoiding the time interval 512 for mandatory portion M₄ from overlapping the time interval 504 for mandatory portion M₃, the starting time of mandatory portion M₃ is changed so that the time interval 504 for mandatory portion M₃ is shifted to the time interval 514 beginning at time 6 and ending at time 8. Finally, mandatory portion M₅ of task T₅ is scheduled in the time interval 516 of the reservation list 406, wherein the time interval 516 begins at time 4 and ends at time 6. Thus, the updating of the time interval of each previously scheduled task and the scheduling of new tasks in the reservation list 406 are completed.

According to the imprecise computation model, tasks inputted into the on-line scheduler 404 are scheduled in the reservation list 406 as many as possible so that the mandatory portion of each scheduled task is to be executed before the deadline of the scheduled task and the optional portions of the scheduled tasks are to be executed as many as possible. Besides, since the task inputted into the on-line scheduler 404, if needed, can be immediately scheduled in the reservation list 406. Thus, it fulfils the requirement for the real-time network transmission.

In addition, a k-tasks-look-ahead substitutable check is provided according to the invention. The k-tasks-look-ahead substitutable check along with the imprecise computation model is used to determine the optimal time intervals in the reservation list 406 for the tasks inputted into the on-line scheduler 404. In this way, the scheduling result, under the conditions that all scheduled tasks have their mandatory portions to be completed by respective deadlines and have their optional portions to be executed as many as possible, achieves optimal scheduling and better quality of service.

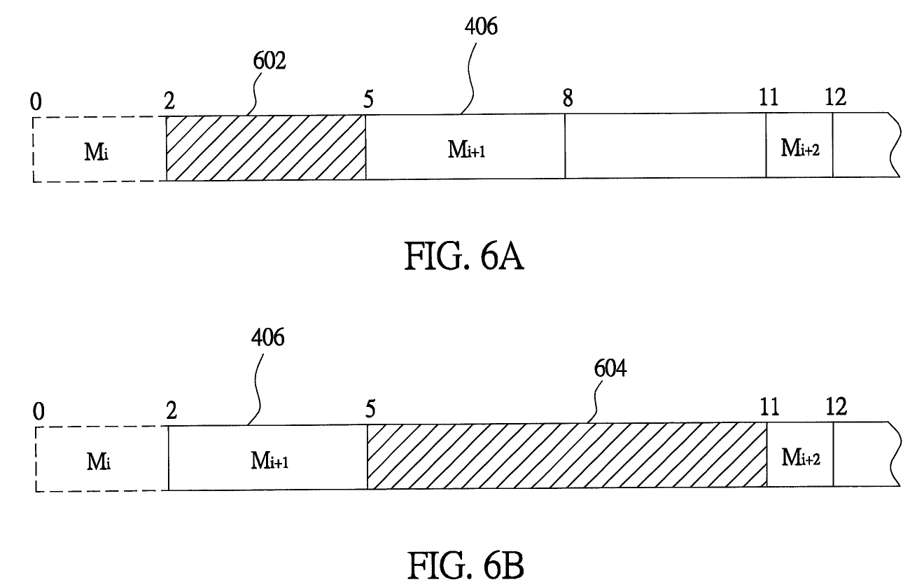

Referring to FIGS. 6A-6B, they illustrate the making of k-tasks-look-ahead substitutable check on the tasks in the reservation list. The k-tasks-look-ahead substitutable check, after the mandatory portion of a task is executed, is used to determine whether the optional portion of the task is k-tasks-look-ahead substitutable so as to determine whether the optional portion of the task is executed or not. First, a spare interval is determined according to the ending time of the executed mandatory portion and the starting time of the mandatory portion waiting to be executed. For example, in FIG. 6A, when mandatory portion Mᵢ of task Tᵢ is completed, a spare interval 602, that is, the time interval between executed mandatory portion Mᵢ and mandatory portion Mᵢ₊₁ waiting to be executed, is determined. As examined from FIG. 6A, the spare interval 602 has a length of time of three time units. From TABLE 2, optional portion Oᵢ of task Tᵢ has a processing time of 4 time units; that is, it requires four time units for execution. If optional portion Oᵢ is to be executed during the spare interval 602, only three time units can be provided for the execution of one proportion of optional portion Oᵢ and, after the spare interval 602, the other proportion of optional portion Oᵢ will not be executed. If optional portion Oᵢ is determined to be executed in the spare interval 602, the time interval (that may be identical to the spare interval 602 or a proportion thereof) for optional portion Oᵢ to execute is called an effective interval tᵢ. The effective interval tᵢ is defined as the smaller one of the spare interval, such as the spare interval 602, and an interval for the processing time of the optional portion Oᵢ. In the case of using the spare interval 602 to execute optional portion Oᵢ, since the spare interval 602 is smaller than the interval for the processing time of the optional portion Oᵢ, the effective interval tᵢ is equal to the spare interval 602 and has a length of three time units.

TABLE 2

| | a | m | o |
|---|---|---|---|
| Tᵢ | 0 | 2 | 4 |
| Tᵢ₊₁ | 0 | 3 | 5 |

Next, mandatory portion Mᵢ₊₁ is assumed to be shifted to the position next to mandatory portion Mᵢ. That is, mandatory portion Mᵢ₊₁ is to be executed immediately after the completion of mandatory portion Mᵢ and optional portion Oᵢ will not be executed. Thus, on this assumption, after mandatory portion Mᵢ₊₁ is completed, a spare interval 604, that is, the time interval between executed mandatory portion Mᵢ₊₁ and the next mandatory portion Mᵢ₊₂ to be executed, is determined and has a length of six time units. In this case, the spare interval 604 is long enough for the execution of optional portion Oᵢ₊₁ of task Tᵢ₊₁. Besides, from TABLE 2, optional portion Oᵢ₊₁ has a processing time of five time units. Thus, the effective interval tᵢ₊₁ is of five time units.

By comparing the effective interval t₁ with the effective interval tᵢ₊₁, a determination as to whether optional portion Oᵢ is k-tasks-look-ahead substitutable is made. As described above, since the effective interval tᵢ is less than the effective interval tᵢ+, it indicates that optional portion Oᵢ is 1-task-look-ahead substitutable. If the effective interval tᵢ is greater than the effective interval tᵢ₊₁, it indicates that optional portion Oᵢ is not 1-task-look-ahead substitutable.

In the determination as to whether some optional portion Oᵢ is k-tasks-look-ahead substitutable, not only the lengths of the spare intervals, such as the lengths of the spare intervals 602 and 604, are concerned, but also the lengths of the effective intervals, such as the lengths of the effective intervals tᵢ and tᵢ₊₁, are concerned, wherein each of the effective intervals is determined as the smaller one of the spare interval and an interval for the processing time of the corresponding optional portion after the shifting of the mandatory portion(s) as described above. After k effective intervals, namely, tᵢ₊₁ to tᵢ₊ₖ, are obtained by the shifting of the mandatory portions in the reservation list as above, the effective intervals tᵢ and the effective intervals t_{i+A} can be compared to determine whether the optional portion Oᵢ is A-task-look-ahead substitutable (where k=1, 2, . . . , k). If the effective interval tᵢ is less than the effective interval t_{i+A}, optional portion Oᵢ is A-task-look-ahead substitutable. If the effective interval tᵢ is greater than the effective interval t_{i+A}, optional portion Oᵢ is not A-task-look-ahead substitutable. Preferably, an effective interval r can be determined according to the k effective intervals tᵢ₊₁, tᵢ₊₂, . . . , t_{i+A}. . . , tᵢ₊ₖ and can be defined as the interval of maximum length among the k effective intervals. If the effective interval tᵢ is less than the effective interval r, optional portion Oᵢ is k-task-look-ahead substitutable. If the effective interval tᵢ is greater than the effective interval r, optional portion Oᵢ is not k-task-look-ahead substitutable.

For instance, suppose that the values of time for execution of the optional portions of tasks Tᵢ and Tᵢ₊₁ are as shown in TABLE 3. Optional portion Oᵢ₊₁ of task Tᵢ₊₁ has a processing time of two time units and, although the spare interval 604 is of six time units, the effective interval tᵢ₊₁ is of two time units. In this case, the effective interval tᵢ is greater than effective interval tᵢ₊₁, indicating that optional portion Oᵢ is not 1-task-look-ahead substitutable.

TABLE 3

| | a | m | o |
|---|---|---|---|
| Tᵢ | 0 | 2 | 4 |
| Tᵢ₊₁ | 0 | 3 | 2 |

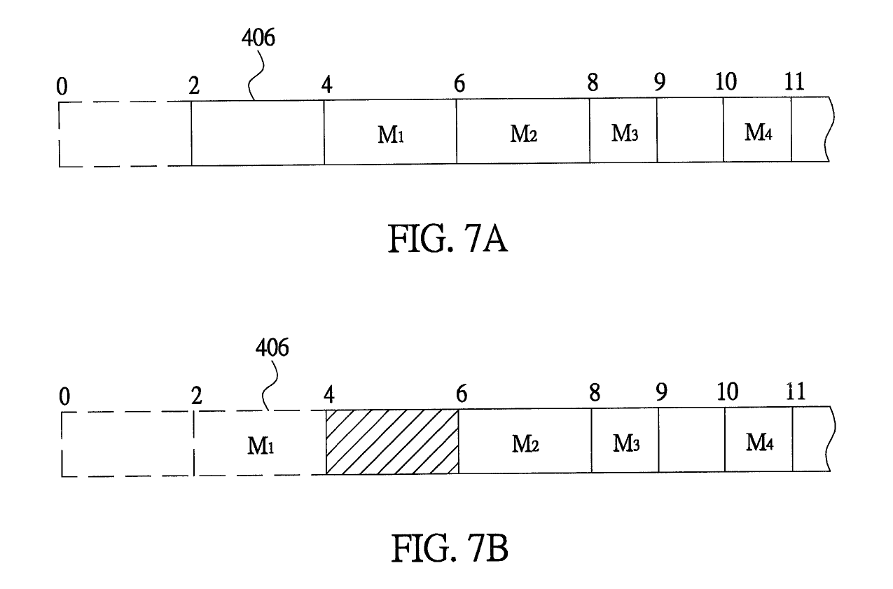

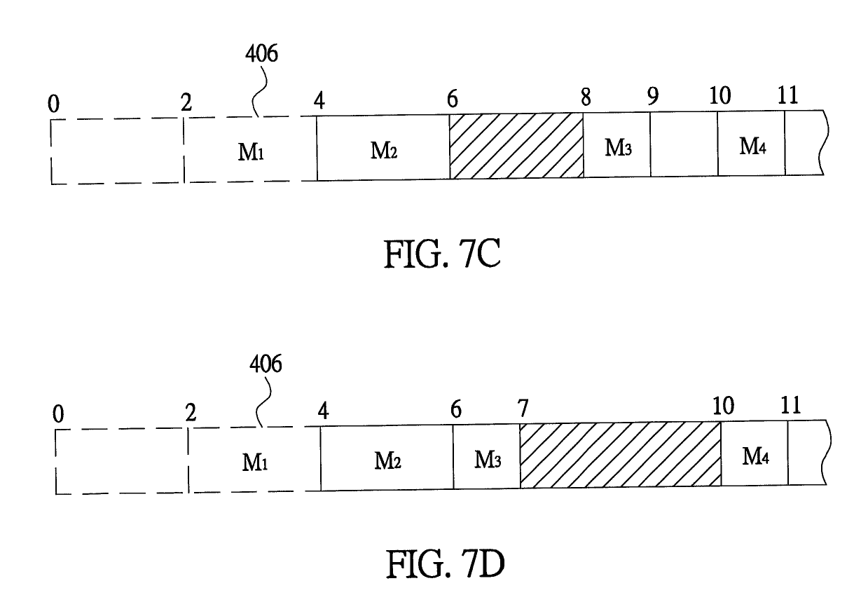

Further, during a k-tasks-look-ahead substitutable check, the value of k can be adjusted to determine whether the optional portion is k-tasks-look-ahead substitutable. Referring to FIGS. 7A-7D, they illustrate the making of k-tasks-look-ahead substitutable checks on the tasks in the reservation list. The values of time for the execution of the mandatory and optional portions of tasks T₁ to T₄ are listed in TABLE 4. FIG. 7A illustrates the result of scheduling mandatory portions M₁ to M₄ in the reservation list 406 by using the imprecise computation model. At time 4, mandatory M₁ is executed and the k-tasks-look-ahead substitutable checks are made as illustrated in FIGS. 7B-7D. Referring now to FIG. 7B, if the next mandatory portion M₂ is not to be shifted to the location adjacent to mandatory portion M₁, the effective interval tᵢ is of two time units. Referring to FIG. 7C, if the next mandatory portion M₂ is shifted to the location adjacent to mandatory portion M₁, the effective interval t₂ is of one time unit because o₂ is equal to one. Referring to FIG. 7D, if mandatory portion M₂ is shifted to the location adjacent to mandatory portion M₁ while mandatory portion M₃ is shifted to the location adjacent to mandatory portion M₂, the effective interval t₃ is of three time units. According to the principle of k-tasks-look-ahead substitutable check described above, optional portion O₁ is not one-task-look-ahead substitutable but it is two-task-look-ahead substitutable. In other words, when making k-tasks-look-ahead substitutable check at time 4 with k equal to one, since optional portion O₁ is not one-task-look-ahead substitutable, optional portion O₁ is to be scheduled in the interval of the reservation list which begins at time 4 and ends at time 6. In this way, optional portion O₁ is not replaced and after optional portion O₁ is completed, mandatory portion M₂ is executed. In the case of k set to two, since optional portion O₁ is two-task-look-ahead substitutable, mandatory portion M₂ is shifted to the location adjacent to mandatory portion M₁ and is to be executed during the interval which begins at time 4 and ends at time 6. In other words, mandatory portion M₂ is substituted for optional portion O₁.

TABLE 4

| | a | D | m | o |
|---|---|---|---|---|
| T₁ | 2 | 6 | 2 | 3 |
| T₂ | 2 | 8 | 2 | 1 |
| T₃ | 2 | 9 | 1 | 4 |
| T₄ | 2 | 11 | 1 | 2 |

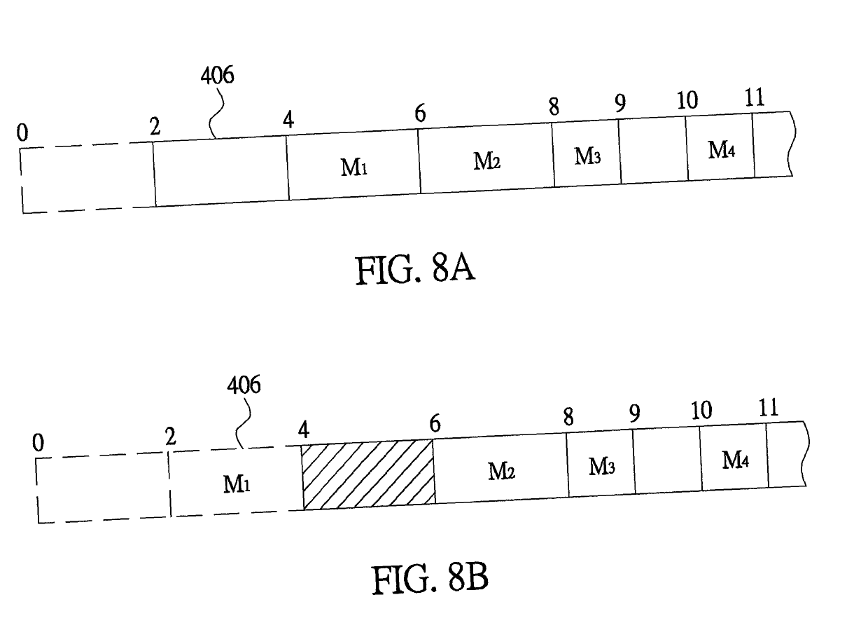

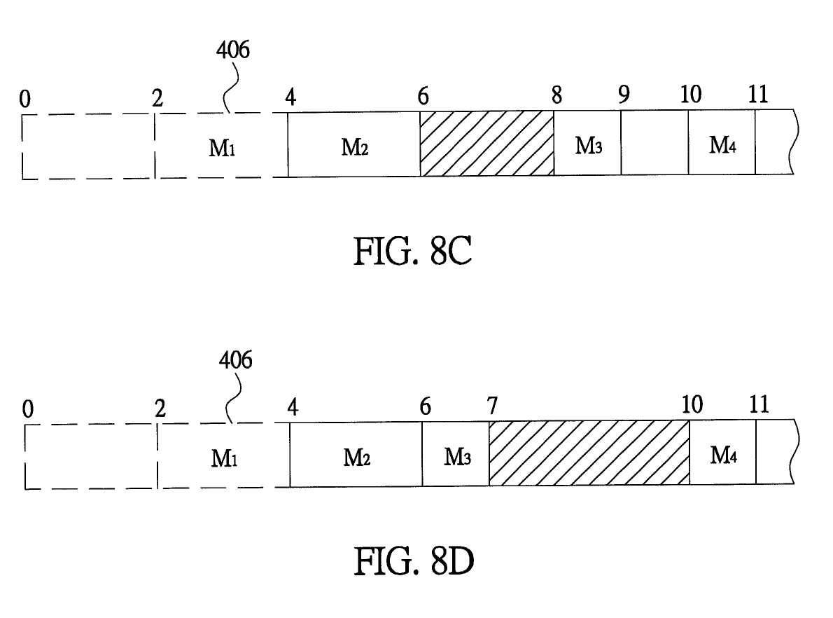

Referring to FIGS. 8A-8D, they illustrate the making of k-tasks-look-ahead substitutable checks on the tasks in the reservation list, wherein k is an integer greater than one. The values of time for the execution of the mandatory and optional portions of tasks T₁ to T₄ are listed in TABLE 5. FIG. 8A illustrates the result of scheduling mandatory portions M₁ to M₄ in the reservation list 406 by using the imprecise computation model. At time 4, mandatory M₁ is executed and, with k equal to two, two-task-look-ahead substitutable check is made as illustrated in FIGS. 8B-8D. Referring now to FIG. 8B, if the next mandatory portion M₂ is not to be shifted to the location adjacent to mandatory portion M₁, the effective interval t₁ is of one time unit (since o₁ is equal to one). Referring to FIG. 8C, if the next mandatory portion M₂ is shifted to the location adjacent to mandatory portion M₁, the effective interval t₂ is of two time units. Referring to FIG. 8D, if the next mandatory portion M₂ is shifted to the location adjacent to mandatory portion M₁ while the following mandatory portion M₃ is shifted to the location adjacent to mandatory portion M₂, the effective interval t₃ is of three time units. By the comparison among these three effective intervals tᵢ, t₂, and t₃, it concludes that optional portion O₁ is one-task-look-ahead substitutable and two-task-look-ahead substitutable.

TABLE 5

| | a | d | m | o |
|---|---|---|---|---|
| T₁ | 2 | 6 | 2 | 1 |
| T₂ | 2 | 8 | 2 | 3 |
| T₃ | 2 | 9 | 1 | 4 |
| T₄ | 2 | 11 | 1 | 2 |

In addition to making the k-tasks-look-ahead substitutable check with k greater than one as above, another way of checking is to be described as follows. Referring to FIGS. 8B and 8C, when it is determined that optional portion O₁ is one-task-look-ahead substitutable, mandatory portion M₂ is to be shifted to the location adjacent to mandatory portion M₁ and is to be executed after mandatory portion M₁ is completed. That is, if the effective interval t₂ (being two time units in length) resulting from shifting mandatory portion M₂ to the location next to mandatory portion M₁, as shown in FIG. 8C, is greater than the effective interval t₁ (being one time unit in length) resulting from without the shifting of mandatory portion M₂ as shown in FIG. 8B, mandatory portion M₂ is to be executed directly after the execution of mandatory portion M₁. Then, it is unnecessary to check for the effective interval t₃ which results from shifting mandatory portion M₂ to the location next to mandatory portion M₁ and shifting mandatory portion M₃ to the location next to mandatory portion M₂. In other words, when a mandatory portion Mᵢ in the reservation list has been executed, k-tasks-look-ahead substitutable check is to be made, where k is an integer greater than one. Once it is determined that optional portion Oᵢ is m-task-look-ahead substitutable with m being less than k, it can be asserted that optional portion Oᵢ is k-tasks-look-ahead substitutable and it is unnecessary to proceed the k-tasks-look-ahead substitutable check. Therefore, the time for the k-tasks-look-ahead substitutable check is reduced, resulting in the improvement of the efficiency.

In brief, the principle of checking k-tasks-look-ahead substitutability is to provide an interval in the reservation list 406 for the task that has as much proportion of its optional portion to be executed as it is possible and to allow its optional portion to be carried out. In this way, the number of optional portions discarded by the on-line scheduler 404 can be reduced to a minimum, fulfilling the requirement for executing the optional portions as much as it is possible. Besides, if k-tasks-look-ahead substitutable check is made on a task with k of larger value, the optional portion of the task is more likely to be k-tasks-look-ahead substitutable. That is, other mandatory portions waiting to be executed in the reservation list 406 are more likely to be shifted in the reservation list 406 so as to be executed earlier than their deadlines, and the spare intervals can be available for scheduling the optional portions of the following tasks. In this way, if there is a new task inputted into the real-time scheduling mechanism 400, the possibility of the new task being fed into the on-line scheduler 404 and scheduled in the reservation list 406 is increased. In other words, the schedulability of the real-time scheduling mechanism 400 is improved. In this regard, the schedulability of the real-time scheduling mechanism 400 relates to the value of k. The possibility of the optional portion being replaced increases as k becomes larger, resulting in improved schedulability. Thus, the schedulability of the real-time scheduling mechanism 400 can be adjusted by setting the value of k.

The k-tasks-look-ahead substitutability has two major features: (1) capability for the optional portion of the task to be executed as much as it is possible, and (2) improvement of the schedulability of the real-time scheduling mechanism 400.

By using an improved imprecise computation model associated with the k-tasks-look-ahead substitutable check, the invention further provides three scheduling methods for use in the on-line scheduler 404. The three scheduling methods are (1) MOS method: the scheduling method that the Mandatory portion is executed as soon as possible and the Optional portion's Substitution will be done as much as possible; (2) MOP method: the scheduling method that the Mandatory portion is executed as soon as possible, and the substitutable Optional portions will be Postponed; and (3) MOF method: the scheduling method that the Mandatory portion is executed as soon as possible, and the Optional portions will be executed Fairly.

These three scheduling methods will be described in details as follows.

1. MOS Method

Firstly, mandatory portions of the tasks inputted into the on-line scheduler 404 are scheduled in the reservation list 406 by using the imprecise computation model. That is, these tasks in the on-line scheduler 404 are assigned time intervals for the tasks to be executed. Secondly, it begins to execute the mandatory portion of the first task scheduled in the reservation list 406. According to the imprecise computation model, the first task has the earliest deadline among deadlines of all tasks in the reservation list 406. During executing the mandatory portion of the task, it needs to determine whether the deadline of the task has reached, or whether it must begin to execute another task according to the reservation list 406. If one of the two events occurs, this task is to be deleted from the reservation list 406 and removed from the on-line scheduler 404, and then it begins to execute the next task. If none of the two events occurs, the mandatory portion of the task is proceeded. When the mandatory portion of the task is executed, it is to check whether the optional portion of the task is k-tasks-look-ahead substitutable by making a k-tasks-look-ahead substitutable check on the optional portion of the task. If so, this task is to be deleted from the reservation list 406 and removed from the on-line scheduler 404, and then it begins to execute the next task. If not, the optional portion of this task begins to be executed. During the execution of the optional portion of the task, it needs to determine, e.g., at every time unit, whether the task has been executed, or whether the deadline of the task has reached, or whether it must begin to execute another task according to the reservation list 406. If it is determined that one of the three events occurs, this task is to be deleted from the reservation list 406 and removed from the on-line scheduler 404, and then it begins to execute the next task. If it is determined that none of the three events occurs, the optional portion of the task is proceeded until it is determined that one of the three conditions occurs. It should be noted that while the on-line scheduler 404 performs the steps described as above, it is possible that an additional task inputted into the on-line scheduler 404 is required to be scheduled in the reservation list 406. For such a new task, the on-line scheduler 404 schedules the new task in the reservation list 406 according to the imprecise computation model and updates the locations for the mandatory portions in the reservation list 406, that is, reschedules all tasks in the reservation list 406 by modifying time intervals for all of the tasks. By repeating the steps described above, the on-line scheduler 404 determines how the tasks are to be executed in sequence and which portion of each task is to be executed until the on-line scheduler 404 has no task to be scheduled.

The MOS method is to execute the mandatory portions of all of the tasks as soon as possible and reserve as much time as possible for the incoming tasks in order to provide an optimal schedulability. Thus, the MOS method is suitable for use in the circumstance in which serious network congestion occurs and under which a large number of tasks are inputted into the real-time scheduling mechanism 400. In another case, if there is no additional tasks inputted into the on-line scheduler 404 which employs the MOS method, the scheduling result that the mandatory portions of the tasks in the reservation list 406 are to be executed as soon as possible causes increased intervals are reserved for the execution of the optional portions of the tasks with later starting times. In this way, the tasks whose mandatory portions are executed earlier have their associated optional portions easily replaced while the tasks whose mandatory portions are executed later have their associated optional portions more probably executed. For the tasks with earlier starting time, especially to the optional portions of these tasks, the fairness of scheduling is insufficient. In brief, for the on-line scheduler 404, the use of the MOS method results in optimal schedulability but reduced fairness of scheduling.

2. MOP Method

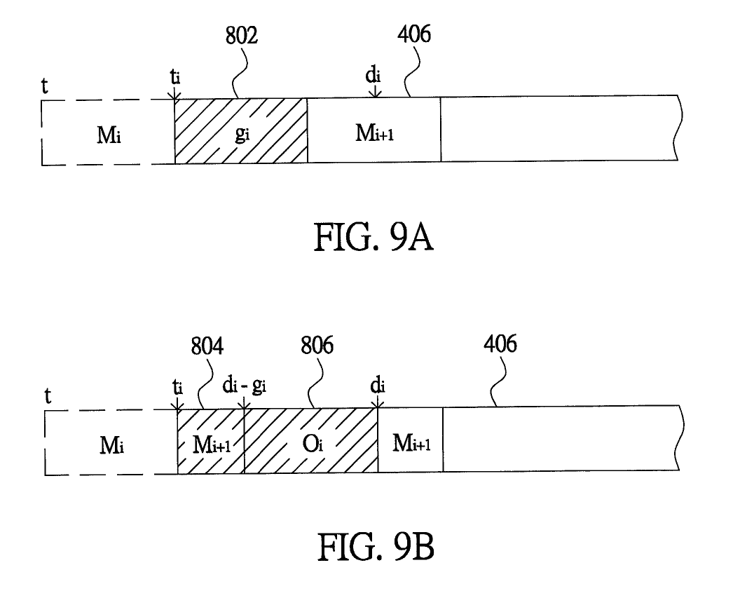

Referring to FIGS. 9A to 9B, they illustrate the MOP method when the mandatory portion is k-tasks-look-ahead substitutable. In the MOP method, the way of scheduling is almost the same as that in the MOS method. The difference between the MOP and MOS methods is: in the MOP method, when it is determined that optional portion Oᵢ of task Tᵢ being executed is k-tasks-look-ahead substitutable by using the k-tasks-look-ahead substitutable check, the following steps are performed.

When mandatory portion Mᵢ is executed, as shown in FIG. 9A, spare interval gᵢ is first defined as interval 802 which has not been taken up by scheduled tasks and is immediately after mandatory portion Mᵢ and immediately before the mandatory portion of the next task to be executed. The mandatory portion of the next task to be executed has its starting time which is a minimum among the starting times which are greater than the ending time of mandatory portion Mᵢ. The length of spare interval gᵢ is determined by the subtraction of the ending time of mandatory portion Mᵢ from the starting time of the mandatory portion of the next task to be executed, i.e. the starting time of mandatory portion Mᵢ₊₁ in FIG. 9A. Next, in FIG. 9B, an insertion time (dᵢ-gᵢ) is obtained by the subtraction of the length of spare interval gᵢ from deadline dᵢ of task Tᵢ. If the insertion time is between the ending time of mandatory portion Mᵢ of task Tᵢ and deadline dᵢ of task Tᵢ, the next mandatory portion to be executed, i.e. Mᵢ₊₁, in the reservation list 406 is rescheduled and is to be executed during the interval 804, and optional portion Oᵢ of task Tᵢ is scheduled to be executed during the interval 806. As can be seen from FIG. 9B, the execution of mandatory portion Mᵢ₊₁ is interrupted at the insertion time (dᵢ-gᵢ) and optional portion Oᵢ is started to be executed as if optional portion Oᵢ were inserted into the reservation list. The length of the interval 804 is determined by the difference between the insertion time (dᵢ-gᵢ) and the ending time of mandatory portion Mᵢ. The length of the interval 806 is determined by the difference between deadline dᵢ of task Tᵢ and the insertion time (dᵢ-gᵢ). During the execution of the scheduled optional portion of the task, the MOP method performs similarly as the MOS method. It needs to determine, e.g., at every time unit, whether the task has been executed, or whether the deadline dᵢ of the task has reached, or whether it must begin to execute another task according to the reservation list 406. If it is determined that one of the three events occurs, this task Tᵢ is to be deleted from the reservation list 406 and removed from the on-line scheduler 404, and the execution of mandatory portion Mᵢ₊₁ of task Tᵢ₊₁ is continued. If it is determined that none of the three events occurs, the execution of the optional portion of the task continues until it is determined that one of the three events occurs. When the insertion time (dᵢ-gᵢ) is not between the time at which mandatory portion Mᵢ of task Tᵢ is completely executed and deadline dᵢ of task Tᵢ, task Tᵢ is to be deleted from the reservation list 406 and removed from the on-line scheduler 404, and then it begins to execute the mandatory portion of the next task.

The spirit of the MOP method is to postpone the execution of the optional portion of the task which is k-tasks-look-ahead substitutable to the later interval rather than to remove the task from the on-line scheduler 404 as the MOS method. In this way, the fairness of scheduling is improved and the schedulability of the scheduling mechanism is capable of being adjusted by setting the value of k for the k-tasks-look-ahead substitutable check.

3. MOF Method

The way of scheduling in MOF method is similar to that in MOS method. In MOF method, when the mandatory portion of Tᵢ is completed, the reservation list is modified as in the MOS method except that if it is determined that the optional portion of task Tᵢ is k-tasks-look-ahead substitutable, it is then to calculate the number of mandatory portions in the first block of consecutive mandatory portions in the reservation list. The first block of consecutive mandatory portions is a block of mandatory portions consecutively scheduled in the reservation list, including the next mandatory portion to be executed. A block separation number is then determined and equal to one plus the number of mandatory portions in the block of consecutive mandatory portions. Next, it is to determine the spare interval between the mandatory portion of the current task Tᵢ and the mandatory portion of the next task Tᵢ₊₁ to be executed. After that, an optional-portion processing period is determined and is defined by the length of the spare interval divided by the block separation number. Processing period equal to the optional-portion processing period is assigned for the execution of each optional portion associated with the mandatory portion of the task Tᵢ and the first block of consecutive mandatory portions. In other words, the spare interval is equally distributed among the tasks associated with the first block of consecutive mandatory portions as well as the current task. Thus, the optional portions of the tasks associated with the first block of consecutive mandatory portions as well as that of the current task are to be executed in the processing periods of equal length and each of the processing periods is equal to the optional-portion processing period as calculated above.

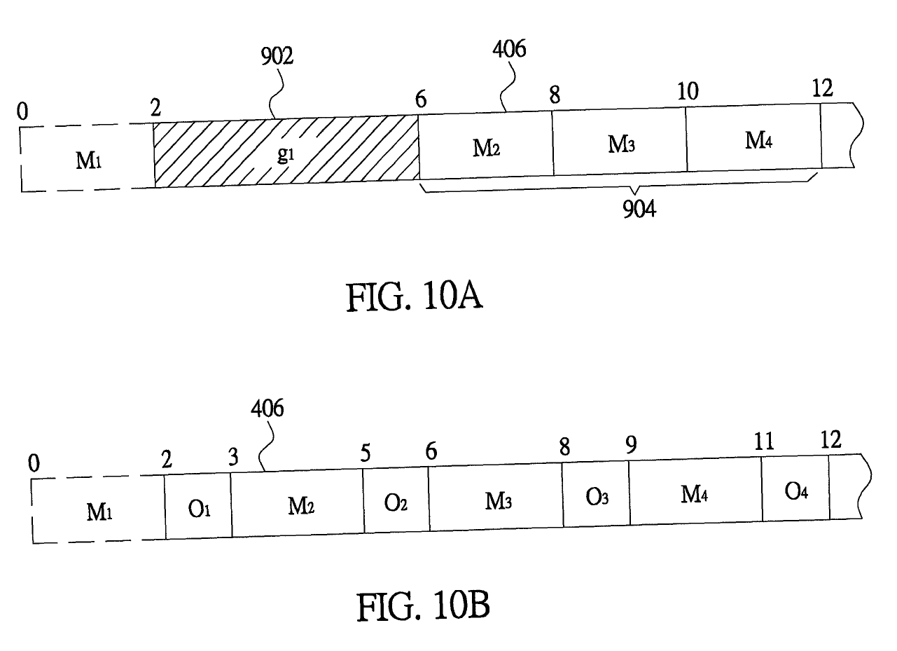

Referring to FIGS. 10A-10B, they illustrate the processing using MOF method when the optional portion is k-tasks-look-ahead substitutable. Mandatory portions M₁ to M₄ of four tasks have been scheduled in the reservation list 406. At time two, the mandatory portion M₁ is completed, and the k-tasks-look-ahead substitutable check on optional portion O₁ is then made, showing that O₁ is k-tasks-look-ahead substitutable. By the MOF method, the following steps are performed. First, calculate the number of mandatory portions in the block of consecutive mandatory portions 904, as shown in FIG. 10A, in the reservation list. The block of consecutive mandatory portions 904 are three mandatory portions consecutively scheduled in the reservation list 406, including M₃, M₄ as well as the next mandatory portion to be executed, M₂. A block separation number is then determined and equal to one plus the number of mandatory portions in the block of consecutive mandatory portions, that is, four. Next, it is determined that the spare interval gᵢ 902 has a length of four time units. In addition, the definition of the spare interval is the same as that of the MOP method. Further, an optional-portion processing period is determined and equal to the length of the spare interval divided by the block separation number, that is, one. In this way, processing period of one time unit is provided for the execution of each of the optional portions of the tasks associated with the three mandatory portions M₂ to M₄ in the block of consecutive mandatory portions to be executed as well as that of the current task. Finally, the scheduling result for the four tasks T₁ to T₄ is illustrated in FIG. 10B.

The optional portion O₁ of the completed mandatory portion M₁ is scheduled to be executed, immediately after the completed mandatory portion M₁, for the optional-portion processing period. After the execution of the optional portion O₁ for this processing period, each mandatory portion in the block of consecutive mandatory portions is scheduled, followed by its associated optional portion which is scheduled to be executed for the optional-portion processing period.

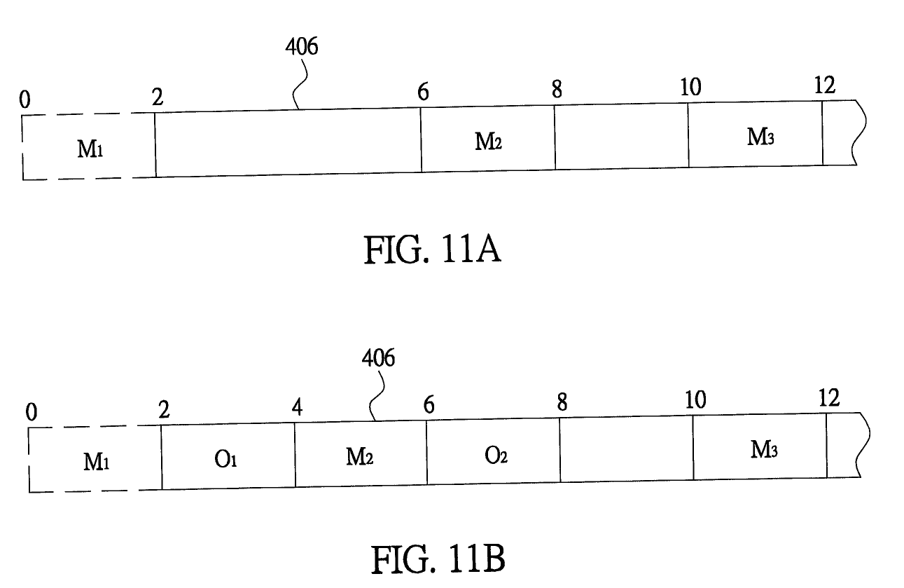

Referring to FIGS. 11A-11B, they illustrate the processing using the MOF method when the mandatory portion is k-tasks-look-ahead substitutable. Referring to FIG. 11A, it illustrates a different pattern of scheduled tasks in which as mandatory portion M₁ is completely executed, the next mandatory portion M₂ is not in a block of consecutive mandatory portions. That is, the ending time for mandatory portions M₂ is not immediately followed by the starting time of any other mandatory portion to be executed. In this case, the block separation number is set to two. Since the spare interval between M₁ and M₂ is of four time units as shown in FIG. 11A, the optional-portion processing period is two time units by the definition, resulting in the optional portions O₁ and O₂ are to be executed for two time units. Thus, the scheduling result is shown as FIG. 11B.

The spirit of the MOF method is: when the optional portion of a completed task is k-tasks-look-ahead substitutable, the spare interval for the optional portion of the completed task is equally distributed among the other tasks to be executed in the reservation list. In this way, the fairness of scheduling is improved. Besides, the schedulability of the scheduling mechanism is capable of being adjusted by setting the value of k for the k-tasks-look-ahead substitutable check.

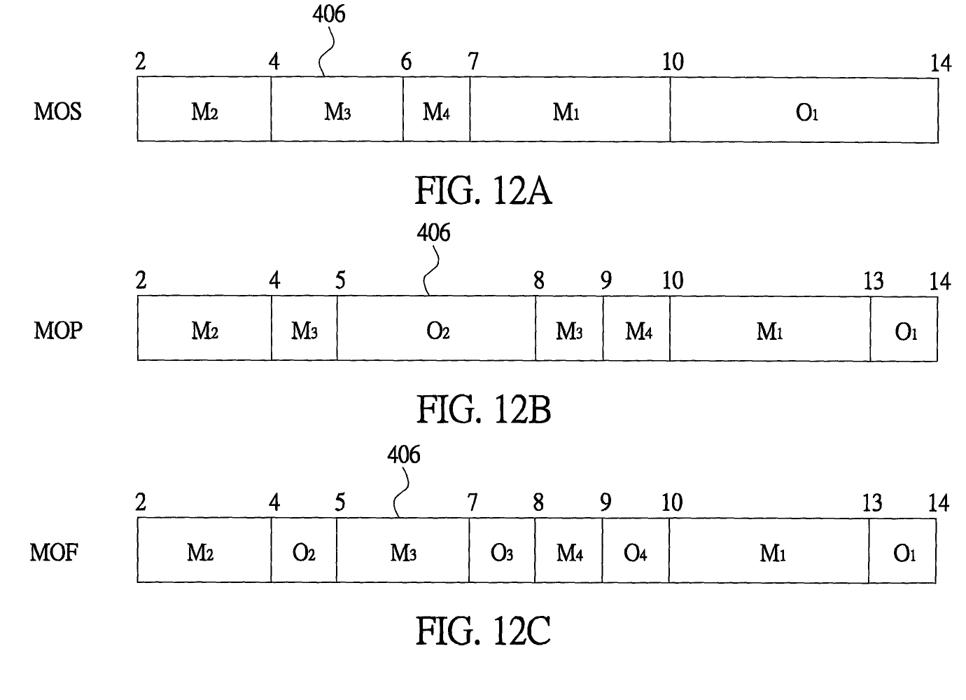

Referring to FIGS. 12A-12C, they illustrate scheduling results obtained by the on-line scheduler which schedules tasks in the reservation list by using MOS, MOP, and MOF methods respectively. The tasks inputted into the on-line scheduler are listed in TABLE 6 and value of k for the k-tasks-look-ahead substitutable check is set to one. In FIG. 12A, a scheduling result is obtained by the on-line scheduler 404 which scheduled tasks in the reservation list by using the MOS method. As can be seen from the scheduling list shown in FIG. 12A, since the MOS method schedules mandatory portions of all tasks to be executed as early as possible, much more time is reserved for the additional tasks which are inputted into the on-line scheduler 404 in the reservation list. Thus, the MOS method has the highest schedulability among the three scheduling methods. However, in this scheduling method, the earlier the mandatory portion of one task is executed, the less possibly the optional portion of this task is to be executed. In this way, the MOS method has the lowest fairness of scheduling among the three scheduling methods.

TABLE 6

| | a | d | m | o |
|---|---|---|---|---|
| T₁ | 2 | 14 | 3 | 4 |
| T₂ | 2 | 8 | 2 | 3 |
| T₃ | 4 | 9 | 2 | 4 |
| T₄ | 4 | 10 | 1 | 3 |

Referring to FIG. 12B, a scheduling result is obtained by the on-line scheduler 404 which schedules tasks in the reservation list by using the MOP method. As can be seen from FIG. 12B, by the MOP method, a subpart of mandatory portion M₃ of task T₃ is first executed and executing mandatory portion O₂ of task T₂ is postponed to time 5. Mandatory portion O₂ of task T₂ is being executed until time 8. Since the deadline of task T₂ is reached at time 8, task T₂ is to be removed from the on-line scheduler 404 and the subpart of mandatory portion M₃ which has not been executed is then to be executed. Compared with the MOS method, the MOP method has higher fairness of scheduling so that one task whose mandatory portion is executed earlier has its optional portion to be executed more probably. However, for the same value of k, the MOP method has lower schedulability than that of the MOS method.

In FIG. 12C, a scheduling result by the on-line scheduler 404 is illustrated, where tasks are scheduled in the reservation list by using the MOF method. As can be seen from FIG. 12C, the mandatory portions M₂, M₃, M₄, M₁ are scheduled followed by the execution of proportions of their optional portions O₂, O₃, O₄, O₁ respectively, where the proportions of the optional portions are scheduled to be executed for an identical length of time, e.g., one time unit. This scheduling result indicates that, before the scheduling result is obtained, a spare interval which is available for the execution of the optional portions has been equally distributed among the tasks scheduled immediately before and after the spare interval, i.e. the tasks T₂, T₃, T₄ and T₁. As compared with both the MOS and MOP methods, the MOF method has the highest fairness of scheduling so that tasks that are scheduled immediately before and after the spare interval have time intervals of equal length of time assigned for the optional portions of the tasks to be executed. However, for the same value of k, the MOF method has the lowest schedulability than that of the MOS and MOP methods.

In addition to the MOS, MOP, and MOF methods described above, the on-line scheduler 404 can apply other scheduling method so as to obtain different scheduling results. As an example of the scheduling method, the execution sequence for tasks is determined according to the deadlines of the tasks. For another instance, all of the mandatory portions of the tasks are to be executed first and the optional portions are to be executed later. Further, the on-line scheduler 404 can adjust the schedulability of the scheduling method by setting a number indicating a maximum allowable execution proportion of the optional portion for each task, denoted by oₘₐₓ If, for each task, the maximum allowable execution proportion of the optional portion is reduced, a reduced proportion of the optional portion for each task is to be executed. In this way, the schedulability of the real-time scheduling mechanism with the reduced oₘₐₓ improves. Conversely, if the maximum allowable execution proportion of the optional portion for each task is increased, the schedulability of the real-time scheduling mechanism degrades.

The on-line scheduler 404 receives a second set of parameters β from an evaluator 408 and selects an appropriate scheduling method according to, for example, a parameter included in the second set of parameters β. For example, the second set of parameters β includes a scheduling method selection parameter s indicative of a selection out of the MOS, MOP, MOF or other scheduling method. In addition, for the real-time scheduling apparatus to make fine adjustments, the second set of parameters β includes a substitutable check parameter indicative of the value of k for k-tasks-look-ahead substitutable check, and set a maximum allowable execution proportion of the optional portion oₘₐₓ for each task, and so on.

When the on-line scheduler 404 selects an appropriate scheduling method, the tasks inputted into the on-line scheduler 404 are to be scheduled in the reservation list 406 and are to be executed according to the execution sequence and proportions of the tasks in the reservation list 406. The evaluator 408 is capable of evaluating the scheduling result from the regulator 402 and the on-line scheduler 404 according to the execution sequence and proportions of the tasks in the reservation list 406.

The criteria that the evaluator 408 uses for evaluation of the scheduling result are:

a. task rejection rate Rᵣ: the rate of the number of tasks not scheduled in the reservation list 406 and that of the tasks inputted into the on-line scheduler 404;

b. task suspend/discard rate R_{sd}: the rate of the number of tasks being suspended by the real-time scheduling device 400 and the tasks being discarded by the real-time scheduling device 400;

c. idle rate Rᵢ: the rate of the period during which the on-line scheduler 404 has no task to be executed and the period during which the on-line scheduler 404 has tasks to be executed; and

d. slack time tₛ: the summation of intervals that have not been distributed to the mandatory portions of tasks for execution.

After evaluating, the evaluator 408 is to send a first set of parameters α to the regulator 402 for the regulator 402 to make coarse adjustments. When the regulator 402 employs the token bucket mechanism, the number of arrival tasks can be adjusted by adjusting the token generation rate ρ, the token number σ, and the queue length Q_{L}. At the same time, the second set of parameters β can be sent to the on-line scheduler 404 for the on-line scheduler 404 to perform fine adjustments. By the fine adjustments, the on-line scheduler 404 selects such as an appropriate scheduling method, a value of k for the k-tasks-look-ahead substitutable check, and a maximum allowable proportion of the optional portion to be executed for each task, denoted by oₘₐₓ, so as to achieve real-time, dynamical, on-line scheduling.

As the embodiments disclosed above, the QoS-controllable real-time scheduling device according to the invention at least provides the following effects.

1. Improved fairness of network resource sharing. In the three scheduling methods provided by the invention, each task is divided into a mandatory portion and an optional portion, and the mandatory portion of each task which is scheduled in the reservation list is to be done by the deadline while the optional portion of each task is to be performed as much as possible. In this way, the requirement for QoS is to be maintained as more tasks are able to be executed. Thus, the fairness of network resource sharing is improved.

2. For use in a real-time system to fulfil on-line scheduling. In addition to the regulator which controls the number of arrival tasks for scheduling by using, for example, a conventional method, an on-line scheduler is employed to achieve an appropriate scheduling result by selecting a scheduling method according to the circumstances. Further, for an optimal scheduling result, an evaluator is used to evaluate the scheduling result immediately so as to make coarse and fine adjustments in the regulator and the on-line scheduler respectively. In this way, the invention can be applied to a real-time system to fulfil on-line scheduling.

While the invention has been described by way of examples and in terms of the preferred embodiment, it is to be understood that the invention is not limited to the disclosed embodiments. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An apparatus for quality-of-service-controllable real-time scheduling, the apparatus comprising:
a regulator for receiving a plurality of tasks for the apparatus;
an on-line scheduler, coupled to the regulator, for selecting a real-time scheduling method and receiving a number of the tasks, wherein the number of the tasks which are inputted to the on-line scheduler are adjusted by the regulator, and the on-line scheduler, according to the real-time scheduling method, is to configure time intervals for inputted tasks to be executed; and
an evaluator, coupled to the regulator and the on-line scheduler, for evaluating a scheduling result of the on-line scheduler, feeding a first set of parameters into the regulator for a coarse adjustment, and feeding a second set of parameters into the on-line scheduler for a fine adjustment.

2. An apparatus according to claim 1, wherein the regulator, the on-line scheduler, and the evaluator are hardware devices.

3. An apparatus according to claim 1, wherein each of the tasks includes a mandatory portion and an optional portion, and the fine adjustment is performed by controlling a proportion of the optional portion to be executed.

4. An apparatus according to claim 1 or 3, wherein the regulator adjusts the number of the tasks inputted to the on-line scheduler according to the first set of parameters.

5. An apparatus according to claim 1 or 3, wherein the on-line scheduler selects the real-time scheduling method according to the second set of parameters.

6. An apparatus according to claim 5, wherein the real-time scheduling method is a scheduling method in which the mandatory portions of the inputted tasks are executed as soon as possible and the optional portions of the inputted tasks are substitutable (MOS method).

7. An apparatus according to claim 5, wherein the real-time scheduling method is a scheduling method in which the mandatory portions of the inputted tasks are executed as soon as possible and the substitutable optional portions of the inputted tasks are postponed (MOP method).

8. An apparatus according to claim 5, wherein the real-time scheduling method is a scheduling method in which the mandatory portions of the inputted tasks are executed as soon as possible and the optional portions of the inputted tasks are to be executed fairly (MOF method).

9. An apparatus according to claim 1 or 3, wherein the evaluator evaluates the scheduling result of the on-line scheduler according an evaluation standard, and the evaluation standard includes a task rejection rate, a task suspend/discard rate, an idle rate, and a slack time.

10. An apparatus according to claim 1 or 3, wherein the first set of parameters includes a token generation rate.

11. An apparatus according to claim 1 or 3, wherein the first set of parameters includes a token number.

12. An apparatus according to claim 1 or 3, wherein the first set of parameters includes a queue length.

13. An apparatus according to claim 1 or 3, wherein the second set of parameters includes a real-time scheduling selection parameter.

14. An apparatus according to claim 1 or 3, wherein the second set of parameters includes a substitutable check parameter.

15. An apparatus according to claim 1 or 3, wherein the second set of parameters includes a parameter indicative of a maximum allowable execution proportion of the optional portion.

16. In a real-time scheduling mechanism for scheduling a plurality of tasks T, a method for 1-task-look-ahead substitutable checking, wherein the plurality of tasks T include respective mandatory portions M and optional portions O, the mandatory portions M of the plurality of tasks T are scheduled in a reservation list according to a model so that each of the mandatory portions Mᵢ scheduled in the reservation list has a starting time sᵢ and an ending time fᵢ, and after the mandatory portion Mᵢ of each of the tasks Tᵢ is completed, the method is performed on the task Tᵢ, wherein, for each of the tasks Tᵢ, the mandatory portion Mᵢ has a processing time mᵢ, the optional portion Oᵢ has a processing time oᵢ, and the subscript i indexes a sequence of starting time for the mandatory portions M scheduled in the reservation list, the method comprising the steps of:
(a) determining an effective interval tᵢ according to the starting time sᵢ₊₁ of the mandatory portion Mᵢ₊₁ of a task Tᵢ₊₁, the ending time fᵢ of the mandatory portion Mᵢ of the task Tᵢ, and an interval for the processing time oᵢ of the optional portion Oᵢ of the task Tᵢ;
(b) moving the mandatory portion Mᵢ₊₁ to a location in the reservation list by setting the starting time sᵢ₊₁ of the mandatory portion Mᵢ₊₁ to be the ending time fᵢ of the mandatory portion Mᵢ and by changing the ending time fᵢ₊₁ of the mandatory portion Mᵢ+correspondingly;
(c) determining an effective interval tᵢ₊₁ according to the starting time sᵢ₊₂ of the mandatory portion Mᵢ₊₂ of a task Tᵢ₊₂, the ending time fᵢ₊₁ of the mandatory portion Mᵢ₊₁, and an interval for the processing time oᵢ₊₁ of the optional portion Oᵢ₊₁ of the task Tᵢ₊₁; and
(d) comparing the effective interval tᵢ with the effective interval tᵢ₊₁; if the effective interval tᵢ is less than the effective interval tᵢ₊₁, the optional portion Oᵢ of the task Tᵢ is 1-task-look-ahead substitutable; if the effective interval tᵢ is greater than the effective interval tᵢ₊₁, the optional portion Oᵢ of the task Tᵢ is not 1-task-look-ahead substitutable.

17. A method according to claim 16, wherein:
said step (a) comprising the steps of:
determining a spare interval pᵢ according to the starting time sᵢ₊₁ and the ending time fᵢ; and
defining the effective interval tᵢ as the smaller one of the spare interval pᵢ and the interval for the processing time oᵢ of the optional portion Oᵢ; and
said step (c) comprising the steps of:
determining a spare interval pᵢ₊₁ according to the starting time sᵢ₊₂ and the ending time fᵢ₊₁; and
defining the effective interval tᵢ₊₁ as the smaller one of the spare interval pᵢ₊₁ and the interval for the processing time oᵢ₊₁ of the optional portion Oᵢ₊₁.

18. In a real-time scheduling mechanism for scheduling a plurality of tasks, a method for k-tasks-look-ahead substitutable checking, where k is an integer greater than one, wherein the plurality of tasks T include respective mandatory portions M and optional portions O, the mandatory portions M of the plurality of tasks T are scheduled in a reservation list according to a model so that each of the mandatory portions Mᵢ scheduled in the reservation list has a starting time sᵢ and an ending time f₁, and after the mandatory portion Mᵢ of each of the tasks Tᵢ is completed, the method is performed on the task Tᵢ, wherein, for each of the tasks Tᵢ, the mandatory portion Mᵢ has a processing time mᵢ, the optional portion Oᵢ has a processing time o₁, and the subscript i indexes a sequence of starting time for the mandatory portions M scheduled in the reservation list, the method comprising the steps of:
(a) determining an effective interval tᵢ according to the starting time sᵢ₊₁ of the mandatory portion Mᵢ₊₁ of a task Tᵢ₊₁, the ending time fᵢ of the mandatory portion Mᵢ of the task Tᵢ, and an interval for the processing time oᵢ of the optional portion O₁ of the task Tᵢ;
(b) setting A to be one;
(c) moving the mandatory portion M_{i+A} of a task T_{i+A} to a location in the reservation list by setting the starting time S_{i+A} of the mandatory portion M_{i+A} to be the ending time f_{i+A-1} of the mandatory portion M_{i+A-1} of a task T_{i+A-1} and by changing the ending time f_{i+A} of the mandatory portion M_{i+A} correspondingly;
(d) determining an effective interval t_{i+A} according to the starting time s_{i+A-1} of the mandatory portion M_{i+A-1} of a task T_{i+A-1}, the ending time f_{i+A-1} of the mandatory portion M_{i+A-1}, and an interval for the processing time O_{i+A} of the optional portion O_{i+A} of the task T_{i+A};
(e) if A is less than k, incrementing A by one and proceeding to said step (c);
(f) determining an effective interval r by using the effective intervals tᵢ₊₁ to tᵢ₊ₖ; and
(g) comparing the effective interval tᵢ with the effective interval r; if the effective interval tᵢ is less than the effective interval r, the optional portion Oᵢ of the task Tᵢ is k-tasks-look-ahead substitutable; if the effective interval tᵢ is greater than the effective interval r, the optional portion Oᵢ of the task Tᵢ is not k-tasks-look-ahead substitutable.

19. A method according to claim 18, wherein said step (a) comprising the steps of:
determining a spare interval pᵢ according to the starting time sᵢ₊₁ and the ending time fᵢ; and
defining the effective interval tᵢ as the smaller one of the spare interval pᵢ and the interval for the processing time oᵢ of the optional portion Oᵢ; and
said step (d) comprising the steps of:
determining a spare interval p_{i+A} according to the starting time s_{i+A-1} and the ending time f_{i+A}; and
defining the effective interval t_{i+A} as the smaller one of the spare interval p_{i+A} and the interval for the processing time o_{i+A} of the optional portion O_{i+A}.

20. A method according to claim 18, wherein in said step (f) the effective interval r is the interval of maximum length among the effective intervals tᵢ₊₁ to tᵢ₊ₖ.

21. In a real-time scheduling mechanism for scheduling a plurality of tasks, a method for k-tasks-look-ahead substitutable checking, where k is an integer greater than one, wherein mandatory portions M of the plurality of tasks T are scheduled in a reservation list according to a model so that each of the mandatory portions Mᵢ scheduled in the reservation list has a starting time sᵢ and an ending time fᵢ, wherein each of the tasks Tᵢ further has an optional portion Oᵢ with processing time o₁, and after the mandatory portion Mᵢ of each of the tasks Tᵢ is completed, the method is performed on the task Tᵢ, where i indexes a sequence of starting time for the mandatory portions M scheduled in the reservation list, the method comprising the steps of:
(a) determining an effective interval tᵢ according to the starting time sᵢ₊₁ of the mandatory portion Mᵢ₊₁ of a task Tᵢ₊₁, the ending time fᵢ of the mandatory portion Mᵢ of the task Tᵢ, and an interval for the processing time oᵢ of the optional portion Oᵢ of the task Tᵢ;
(b) setting A to be one;
(c) changing the location of the mandatory portion MᵢA of a task T_{i+A} in the reservation list by setting the starting time S_{i+A} of the mandatory portion M_{i+A} to be the ending time f_{i+A-1} of the mandatory portion M_{i+A-1} of a task T_{i+A-1} and by changing the ending time f_{i+A} of the mandatory portion M_{i+A} correspondingly;
(d) determining an effective interval t_{i+A} according to the starting time s_{i+A-1} of the mandatory portion M_{i+A-1} of a task T_{i+A-1}, the ending time f_{i+A-1} of the mandatory portion M_{i+A-1}, and an interval for the processing time O_{i+A} of the optional portion O_{i+A} of the task T_{i+A};
(e) comparing the effective interval tᵢ with the effective interval t_{i+A}; if the effective interval tᵢ is less than the effective interval t_{i+A}, the optional portion Oᵢ of the task Tᵢ is k-tasks-look-ahead substitutable; if the effective interval tᵢ is greater than the effective interval t_{i+A}, the optional portion Oᵢ of the task Tᵢ is not k-tasks-look-ahead substitutable;
(f) ending the method if the optional portion O₁ of the task Tᵢ is k-tasks-look-ahead substitutable; and
(g) if A is less than k, incrementing A by one and proceeding to said step (c);

22. A method according to claim 21, wherein said step (a) comprising the steps of:
determining a spare interval pᵢ according to the starting time sᵢ₊₁ and the ending time fᵢ; and
defining the effective interval tᵢ as the smaller one of the spare interval pᵢ and an interval for the processing time oᵢ of the optional portion Oᵢ; and
said step (d) comprising the steps of:
determining a spare interval P_{i+A} according to the starting time s_{i+A-1} and the ending time f_{i+A}; and
defining the effective interval t_{i+A} as the smaller one of the spare interval P_{i+A} and the interval for the processing time O_{i+A} of the optional portion O_{i+A}.

23. In an on-line scheduler for scheduling n tasks, T₁ to Tₙ, with a reservation list, a real-time scheduling method, wherein the reservation list has at most u tasks to be put into, each of the tasks Tₕ has a mandatory portion Mₕ, an optional portion Oₕ, a mandatory portion processing time mₕ, and a deadline dₕ, where n is an integer greater than one and h is an integer not less than zero and not greater than n, the real-time scheduling method comprising:
a1. determining whether there are any mandatory portions in the reservation list; if not, proceeding to step d3;
a2. determining whether there is a mandatory portion waiting to be put into the reservation list; if so, putting the mandatory portion into the reservation list according to an imprecise computation model so that the reservation list hasp mandatory portions, wherein p is an integer not greater than u, and the p mandatory portions have respective starting times denoted by s with subscripts identical to subscripts of the p mandatory portions;
b1. determining whether there is a mandatory portion Mᵢ in the reservation list is scheduled to be executed immediately, where i is not less than one and not greater than p; if so, proceeding to step b3;
b2. selecting a mandatory portion Mᵢ from the p mandatory portions M in the reservation list according to the starting times of the mandatory portions M, and updating the starting time sᵢ of the mandatory portion Mᵢ;
b3. starting to execute the mandatory portion Mᵢ and executing said step a2 until the mandatory portion Mᵢ is completed;
c1. determining whether the optional portion Oᵢ of the task Tᵢ is k-tasks-look-ahead substitutable; if not, proceeding to step c4;
c2. removing the task Tᵢ from the on-line scheduler;
c3. proceeding to said step a1;
c4. starting to execute the optional portion Oᵢ of the task Tᵢ, executing said step a2, and then executing step c8 after the execution of said step a2;
c5. determining whether a mandatory portion Mⱼ is to be executed according to the reservation list, where j is an integer not less than one and not greater than p and not equal to i; if so, proceeding to step c8;
c6. determining whether the task Tᵢ is completed; if so, proceeding to step c8;
c7. determining whether the deadline dᵢ of the task Tᵢ is reached; if not, proceeding with said step c4;
c8. removing the task Tᵢ from the on-line scheduler;
d1. determining whether there is a task in the on-line scheduler; if not, proceeding to step d3;
d2. proceeding to said step a1; and
d3. ending the method.

24. A real-time scheduling method according to claim 23, wherein, in said step b1, the starting time sᵢ of the mandatory portion Mᵢ is the minimum among the values of starting time associated with the p mandatory portions.

25. In an on-line scheduler for scheduling n tasks, T₁ to Tₙ, with a reservation list, a real-time scheduling method, wherein the reservation list has at most u tasks to be scheduled in, each of the tasks Tₕ has a mandatory portion Mₕ, an optional portion Oₕ, a mandatory portion processing time mₕ, and a deadline dₕ, where n is an integer greater than one and h is an integer not less than zero and not greater than n, the real-time scheduling method comprising:
a1. determining whether there are any mandatory portions in the reservation list; if not, proceeding to step d3;
a2. determining whether there is a mandatory portion waiting to be put into the reservation list; if so, putting the mandatory portion into the reservation list according to an imprecise computation model so that the reservation list hasp mandatory portions, wherein each of the p mandatory portions Mₖ has a starting time sₖ and an ending time eₖ, where p is an integer not greater than u and k is an integer not greater than u;
b1. determining whether there is a mandatory portion Mᵢ in the reservation list is scheduled to be executed immediately, where i is not less than one and not greater than p; if so, proceeding to step b3;
b2. selecting a mandatory portion Mᵢ from the p mandatory portions M in the reservation list according to the starting times of the mandatory portions M, and updating the starting time sᵢ of the mandatory portion Mᵢ;
b3. starting to execute the mandatory portion Mᵢ and executing said step a2 until the mandatory portion Mᵢ is completed;
c1. determining whether the optional portion Oᵢ of the task Tᵢ is k-tasks-look-ahead substitutable; if not, proceeding to step c12;
c2. selecting a mandatory portion M_{q} from the reservation list, wherein a starting time s_{q} of the mandatory portion M_{q} is a minimum among the starting times which are greater than the ending time eᵢ of the mandatory portion Mᵢ, and q is an integer not less than one and not greater than p;
c3. determining a spare interval gᵢ, wherein the spare interval gᵢ is defined by the starting time s_{q} and the ending time eᵢ and has a length defined by the difference between the starting time s_{q} and the ending time eᵢ;
c4. determining an insertion time vᵢ, wherein the insertion time vᵢ is defined by the difference between the deadline dᵢ and the length of the spare interval gᵢ;
c5. determining whether the insertion time vᵢ is greater than the ending time e₁ and less than the deadline dᵢ; if so, proceeding to step c8;
c6. removing the task Tᵢ from the on-line scheduler;
c7. proceeding to said step a1;
c8. starting to execute the mandatory portion M_{q} and executing said step a2 until the mandatory portion M_{q} is completed;
c9. starting to execute the optional portion Oᵢ of the task Tᵢ, executing said step a2, and then executing step c11 after the execution of said step a2;
c10. determining whether a mandatory portion Mⱼ is to be executed according to the reservation list, where j is an integer not less than one and not greater than p and not equal to i; if so, proceeding to step c13;
c11. determining whether the task Tᵢ is completed; if so, proceeding to step c13;
c12. determining whether the deadline dᵢ of the task Tᵢ is reached; if not, proceeding to said step c9;
c13. removing the task Tᵢ from the on-line scheduler;
d1. determining whether there are any tasks in the on-line scheduler; if not, proceeding to step d3;
d2. proceeding to said step a1; and
d3. ending the method.

26. A real-time scheduling method according to claim 25, wherein, in said step b1, the starting time sᵢ of the mandatory portion Mᵢ is the minimum among the starting times associated with the p mandatory portions M.

27. In an on-line scheduler for scheduling n tasks, T₁ to Tₙ, with a reservation list, a real-time scheduling method, wherein the reservation list has at most u tasks to be put into, each of the tasks Tₕ has a mandatory portion Mₕ, an optional portion Oₕ, a mandatory portion processing time mₕ, and a deadline dₕ, where n is an integer greater than one and h is an integer not less than one and not greater than n, the real-time scheduling method comprising:
a1. determining whether there are any mandatory portions in the reservation list; if not, proceeding to step d3;
a2. determining whether there is a mandatory portion waiting to be put into the reservation list; if so, putting the mandatory portion M into the reservation list according to an imprecise computation model so that the reservation list hasp mandatory portions, wherein p is an integer greater than r and not greater than u, and each of the p mandatory portions Mₖ has a starting time sₖ and an ending time eₖ, where p is an integer not greater than u and k is an integer not greater than u;
b1. determining whether there is a the mandatory portion Mᵢ in the reservation list is scheduled to be executed immediately, where i is not less than one and not greater than p; if so, proceeding to step b3;
b2. selecting a mandatory portion Mᵢ from the p mandatory portions in the reservation list according to the starting times of the mandatory portions M, and updating the starting time sᵢ of the mandatory portion Mᵢ;
b3. starting to execute the mandatory portion Mᵢ and executing said step a2 until the mandatory portion Mᵢ is completed;
c1. determining whether the optional portion Oᵢ of the task Tᵢ is k-tasks-look-ahead substitutable; if not, proceeding to step c7;
c2. determining a block separation number bᵢ, wherein the block separation number bᵢ is one plus the number of a mandatory portion set in the reservation list;
c3. selecting a mandatory portion M_{q} from the reservation list, wherein the mandatory portion M_{q} belongs to the mandatory portion set, and the starting time S_{q} of the mandatory portion M_{q} is a minimum among starting times associated with the mandatory portion set and is greater than the ending time eᵢ, and subscript q is an integer not less than one and not greater than p;
c4. determining a spare interval gᵢ, wherein the spare interval gᵢ is defined by the starting time s_{q} and the ending time eᵢ and has a length defined by the difference between the starting time s_{q} and the ending time eᵢ;
c5. determining an optional-portion processing period oₜ, wherein the optional-portion processing period oₜ is defined by the length of the spare interval gᵢ divided by the block separation number bᵢ;
c6. starting to execute the optional portion Oᵢ of the task Tᵢ for the optional-portion processing period ot, and executing said step a2 until the optional portion Oᵢ of the task Tᵢ has been executed for optional-portion processing period oₜ;
c7. removing the task Tᵢ from on-line scheduler;
c8. starting to execute a task Tᵣ associated with one of the mandatory portion set beginning from the mandatory portion M_{q} according to the starting times of the mandatory portions in the mandatory portion set, until all of the mandatory portions in the mandatory portion set are executed and all optional portions associated with the mandatory portions in the mandatory portion set are executed for the optional-portion processing period oₜ;
d1. determining whether there are any tasks in the on-line scheduler; if not, proceeding to step d3;
d2. proceeding to said step a1; and
d3. ending the method.

28. A real-time scheduling method according to claim 27, wherein, in said step b1, the starting time sᵢ of the mandatory portion Mᵢ is the minimum among the starting times of the p mandatory portions.

29. A real-time scheduling method according to claim 27, wherein, in said step c2, the optional portion set is a block of consecutive mandatory portions including the mandatory portion M_{q}.

30. A real-time scheduling method according to claim 27, wherein, in said step c2, the block separation number bᵢ is set to two when the mandatory portion M_{q} is not immediately followed by another mandatory portion in the reservation list and the mandatory portion set contains the mandatory portion Mq only.

31. A real-time scheduling method according to claim 27, wherein said step c8 comprises the steps of:
executing a mandatory portion Mᵣ of the task Tᵣ;
starting to execute an optional portion Oᵣ of the task Tᵣ until the optional portion Oᵣ of the task Tᵣ has been executed for the optional-portion processing period oₜ;
removing the task Tᵣ from the on-line scheduler; and
proceeding to said step of executing a mandatory portion Mᵣ of the task Tᵣ for a mandatory portion with the earliest starting time among the mandatory portions of the mandatory portion set that have not been executed, until the mandatory portions of the mandatory portion set are executed.

32. A method for quality-of-service-controllable real-time scheduling, the method comprising the steps of:
(a) regulating the number of input tasks which are to be forwarded to an on-line scheduling unit through a regulating unit;
(b) by the on-line scheduling unit, selecting a real-time scheduling method, scheduling tasks forwarded to the on-line scheduling unit according to the real-time scheduling method, and outputting a scheduling result; and
(c) by an evaluating unit, evaluating the scheduling result, feeding a first set of parameters into the regulating unit for a coarse adjustment, and feeding a second set of parameters into the on-line scheduler for a fine adjustment.

33. A method according to claim 32, wherein the regulating unit, the on-line scheduling unit, and the evaluating unit are implemented as respective software routines.

34. A method according to claim 32, wherein each of the tasks includes a mandatory portion and an optional portion, and the coarse adjustment is performed by controlling a proportion of the optional portion to be executed.

35. A method according to claim 32 or 34, wherein said step (a) is performed by the regulating unit according to the first set of parameters.

36. A method according to claim 32 or 34, wherein, in said step (b), the real-time scheduling method is selected according to the second set of parameters.

37. A method according to claim 36, wherein the real-time scheduling method is a scheduling method in which the mandatory portions of the input tasks are executed as soon as possible and the optional portions of the inputted tasks are substitutable (MOS method).

38. A method according to claim 36, wherein the real-time scheduling method is a scheduling method in which the mandatory portions of the input tasks are executed as soon as possible and the substitutable optional portions of the inputted tasks are postponed (MOP method).

39. A method according to claim 36, wherein the real-time scheduling method is a scheduling method in which the mandatory portions of the input tasks are executed as soon as possible and the optional portions of the inputted tasks are to be executed fairly (MOF method).

40. A method according to claim 32 or 34, wherein, in said step (c), the evaluating unit evaluates the scheduling result according an evaluation standard, and the evaluation standard includes a task rejection rate.

41. A method according to claim 32 or 34, wherein, in said step (c), the evaluating unit evaluates the scheduling result according an evaluation standard, and the evaluation standard includes a task suspend/discard rate.

42. A method according to claim 32 or 34, wherein, in said step (c), the evaluating unit evaluates the scheduling result according an evaluation standard, and the evaluation standard includes an idle rate.

43. A method according to claim 32 or 34, wherein, in said step (c), the evaluating unit evaluates the scheduling result according an evaluation standard, and the evaluation standard includes a slack time.

44. A method according to claim 32 or 34, wherein the first set of parameters includes a token generation rate.

45. A method according to claim 32 or 34, wherein the first set of parameters includes a token number.

46. A method according to claim 32 or 34, wherein the first set of parameters includes a queue length.

47. A method according to claim 32 or 34, wherein the second set of parameters includes a real-time scheduling selection parameter.

48. A method according to claim 32 or 34, wherein the second set of parameters includes a substitutable check parameter.

49. A method according to claim 32 or 34, wherein the second set of parameters includes a parameter indicative of a maximum allowable execution proportion of the optional portion.
